(19) United States
(12) Patent Application Publication
(10) Pub. No.: US 2023/0130442 A1
(43) Pub. Date: Apr. 27, 2023

(54) QUANTUM SEARCH ON N CHOOSE K STATES AND CIRCUITS FOR USE THEREWITH

(71) Applicants: BEIT Sp. z o.o., Kraków (PL); BEIT Inc., Millbrae, CA (US)

(72) Inventors: Marcin Brianski, Chorzow (PL); Konrad Deka, Kraków (PL); Jan Marian Gwinner, Kraków (PL)

(73) Assignees: BEIT Sp. z o.o., Krakow (PL); BEIT Inc., Millbrae, CA (US)

(21) Appl. No.: 17/936,621

(22) Filed: Sep. 29, 2022

Related U.S. Application Data
(60) Provisional application No. 63/262,731, filed on Oct. 19, 2021.
(60) Provisional application No. 63/317,416, filed on Mar. 7, 2022.
(60) Provisional application No. 63/324,359, filed on Mar. 28, 2022.
(60) Provisional application No. 63/324,364, filed on Mar. 28, 2022.
(60) Provisional application No. 63/324,373, filed on Mar. 28, 2022.
(60) Provisional application No. 63/324,380, filed on Mar. 28, 2022.
(60) Provisional application No. 63/324,383, filed on Mar. 28, 2022.

(51) Int. Cl. G06N 10/20

(52) U.S. Cl. CPC G06N 10/20

(57) ABSTRACT

A quantum circuit includes a state preparation circuit, that prepares an n choose k state on n qubits, an oracle, and a microdiffuser circuit. Wherein, for each in a sequence of iterations, the oracle and the microdiffuser circuit are applied, wherein the microdiffuser circuit operates on a subset of n qubits of varying size over the sequence of iterations, wherein for the jth iteration of the sequence of iterations, the microdiffuser circuit operates on a subset of n qubits of size mⱼ, and wherein a measurement is applied to the n qubits.

### CROSS REFERENCE TO RELATED APPLICATIONS

The present U.S. Utility patent application claims priority pursuant to 35 U.S.C. § 119(e) to U.S. Provisional Application No. 63/262,731, entitled “METHODS OF PREPARING N CHOOSE K STATES AND PARTIAL DIFFUSERS OVER THE SUBSPACE SPANNED BY THEM”, filed Oct. 19, 2021; U.S. Provisional Application No. 63/317,416, entitled “QUANTUM SEARCH ON A NONSTANDARD SPACE AND CIRCUITS FOR USE THEREWITH”, filed Mar. 7, 2022; U.S. Provisional Application No. 63/324,359, entitled “QUANTUM SEARCH ON A NONSTANDARD SPACE AND CIRCUITS FOR USE THEREWITH”, filed Mar. 28, 2022; U.S. Provisional Application No. 63/324,364, entitled “QUANTUM SEARCH ON N CHOOSE K STATES AND CIRCUITS FOR USE THEREWITH”, filed Mar. 28, 2022; U.S. Provisional Application No. 63/324,373, entitled “AUXILIARY QUANTUM CIRCUITS AND METHODS FOR GENERATION THEREOF”, filed Mar. 28, 2022; U.S. Provisional Application No. 63/324,380, entitled “QUANTUM CIRCUITS FOR STATE PREPARATION”, filed Mar. 28, 2022; and U.S. Provisional Application No. 63/324,383, entitled “QUANTUM CIRCUITS FOR MICRODIFFUSION”, filed Mar. 28, 2022, all of which are hereby incorporated herein by reference in their entirety and made part of the present U.S. Utility patent application for all purposes.

### BACKGROUND OF THE DISCLOSURE

### Technical Field of the Disclosure

This disclosure relates generally to computer systems and particularly to quantum computing.

### Description of Related Art

Computing devices are known to communicate data, process data, and/or store data. Such computing devices range from wireless smart phones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, a quantum computer utilizes quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a schematic block diagram of a prior art quantum circuit;

FIG. 1B is a block diagram of an example of a quantum computing architecture in accordance with the present disclosure;

FIG. 2A is a schematic block diagram of an example of a quantum circuit in accordance with the present disclosure;

FIG. 2B is a schematic block diagram of an example of a quantum circuit in accordance with the present disclosure;

FIG. 2C is a schematic block diagram of an example of a quantum circuit in accordance with the present disclosure;

FIG. 2D is a schematic block diagram of an example of a quantum circuit in accordance with the present disclosure;

FIG. 3A is a schematic block diagram of an example of a quantum circuit in accordance with the present disclosure;

FIG. 3B is a schematic block diagram of an example of a quantum circuit in accordance with the present disclosure;

FIG. 4A is a schematic block diagram of an example of a quantum circuit in accordance with the present disclosure;

FIG. 4B is a schematic block diagram of an example of a quantum circuit in accordance with the present disclosure;

FIG. 5 is a schematic block diagram of an example of a quantum circuit in accordance with the present disclosure;

FIG. 6 is a schematic block diagram of an example of a quantum circuit in accordance with the present disclosure;

FIG. 7 is a flow diagram of an example of a method in accordance with the present disclosure;

FIG. 8 is a flow diagram of an example of a method in accordance with the present disclosure;

FIG. 9 is a flow diagram of an example of a method in accordance with the present disclosure;

FIG. 10A is a flow diagram of an example of a method in accordance with the present disclosure;

FIG. 10B is a schematic block diagram of an example of a quantum circuit in accordance with the present disclosure;

FIG. 10C is a schematic block diagram of an example of a quantum circuit in accordance with the present disclosure;

FIG. 11 is a schematic block diagram of an example of a quantum circuit in accordance with the present disclosure;

FIG. 12 is a flow diagram of an example of a method in accordance with the present disclosure;

FIG. 13 is a schematic block diagram of an example of a quantum circuit in accordance with the present disclosure;

FIG. 14 is a schematic block diagram of an example of a quantum circuit in accordance with the present disclosure; and

FIG. 15 is a schematic block diagram of an example of a quantum circuit in accordance with the present disclosure.

FIG. 16 is a schematic block diagram of an example of a quantum circuit in accordance with the present disclosure;

FIG. 17 is a schematic block diagram of an example of a quantum circuit in accordance with the present disclosure;

FIG. 18 is a schematic block diagram of an example of a quantum circuit in accordance with the present disclosure;

FIG. 19 is a schematic block diagram of an example of a quantum circuit in accordance with the present disclosure;

FIG. 20 is a schematic block diagram of an example of a quantum circuit in accordance with the present disclosure; and

FIG. 21 is a schematic block diagram of an example of a quantum circuit in accordance with the present disclosure.

FIG. 22 is a schematic block diagram of an example of a quantum circuit in accordance with the present disclosure.

### DETAILED DESCRIPTION OF THE DISCLOSURE

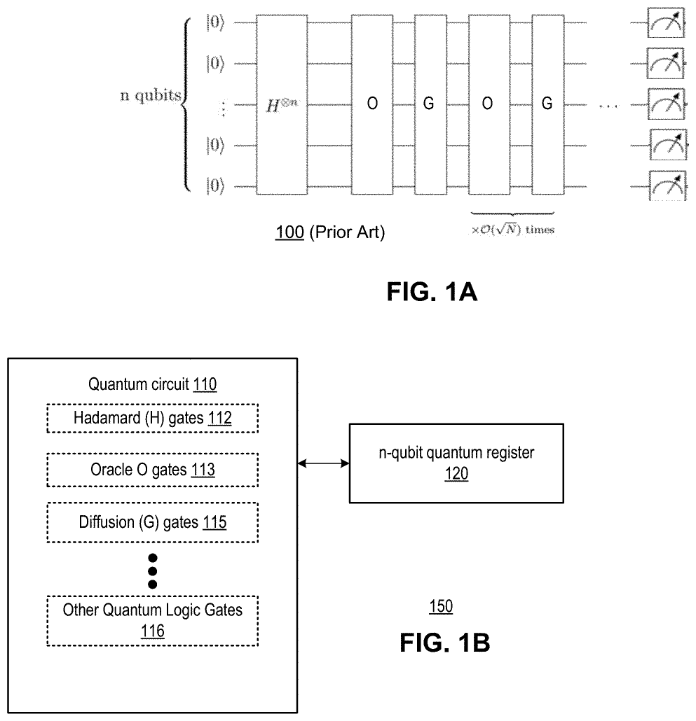

FIG. 1A is a schematic block diagram 100 of a prior art quantum circuit. In particular, a quantum circuit implementation of Grover's algorithm is presented. Grover's algorithm is a quantum algorithm that finds, with high probability, a quantum solution. Grover's algorithm is based on the unique input to a black box function called a “quantum oracle”, “oracle operator”, “oracle function” or simply “oracle” that produces a particular output value. Grover's algorithm converges in just O(sqrt(N)) evaluations of the oracle function, where N is the size of the function's domain. Grover's algorithm has been applied to the problem of unstructured database search, or more generally the inversion of a function.

In operation, n qubits are initialized and applied to a corresponding number of Hadamard (H) gates. Each input is Hadamard transformed in order to achieve a uniform superposition of all the initial states. An oracle gate (O) performs an oracle call for each of the transformed qubit states and a diffusion gate (G) performs the Grover diffusion operator. This process is repeated O(sqrt(N)) times. A measurement of the qubits after this point yields the quantum solution with a probability that approaches 1 for large values of N. See e.g., John Wright, Lecture 4: Grover's Algorithm, Carnegie Mellon University, Sep. 21, 2015.

FIG. 1B is a block diagram 150 of an example of a quantum computing architecture in accordance with the present disclosure. In particular, a quantum circuit 110 is presented that includes one or more Hadamard (H) gates 112 that apply Hadamard transforms to one or more of the plurality of qubits; oracle (O) gates 113 that call a quantum oracle operator on the corresponding plurality of qubits (e.g. qubit states) to produce a sequence of quantum oracle calls; and/or Grover diffusion gates (G) 115 that apply one or more different diffusion operators. In particular, a plurality of diffusion gates (G), can be used to apply a plurality of different diffusion operators, wherein a selected one or more of a plurality of diffusion operators is applied after each of the quantum oracle calls in the sequence of oracle calls. While a plurality of different diffusion operators are used, one or more of these different diffusion operators can be applied more than once. The other quantum logic gates 116, when present, can further include X gates, Y gates, Z gates, phase shift gates, controlled gates, such as CX, CY and/or CZ gates, swap gates, Toffoli gates, Deutsch gates, Ising gates, Fredkin gates, Adalus gates and/or other quantum logic gates and combinations thereof in various circuit configurations. In operation, the quantum circuit 110 generates a quantum computing result based on a measurement from the plurality of qubits—with or without the use of additional (ancillary or ancilla) working qubits.

Consider an example implementation of Grover's algorithm where a quantum circuit 110 uses oracle testing for the solution in an n-qubit quantum computer register 120 containing the superposition of all the candidate solutions—created using Hadamard transforms on the qubits in said register and may or might not use additional (ancillary) working qubits. As used in this context, the quantum oracle function can be part of or external to the computation pictured. Furthermore, the oracle function can be a “black box” or be another quantum function where the gates constituting it can be modified or otherwise produce an oracle result, as a part of the computation described (e.g., like a function testing the satisfiability of a set of clauses by the assignments of variables in the superposition). Unlike quantum circuits that rely on Grover's algorithm that uses a single Grover's diffusion operator after each oracle call) the quantum circuit employs at least two different diffusion operators, at least one of them being used after each oracle call. The quantum circuit 110 can further be used in circuit implementations of other quantum solutions, in addition to the example implementation of Grover's Algorithm above.

The different diffusion operators can operate similarly to Grover's diffusion operator, but operate on only a subset of wirelines/qubits, as opposed to all of the qubits in the register. In various examples, each of the plurality of diffusion operators operates on a unique (different) non-zero proper subset of the plurality of qubits. These different diffusion operators can include, for example, 2-qubit operators acting only on neighboring qubits, however, other examples operating on p-neighboring qubits (including p=1 or p>2), and/or other selected subsets of qubits, etc., can likewise be employed. Other non-Grover diffusion operators can be employed as well. Furthermore, the diffusion operators may or may not act on the same qubits and may or may not be identical up to the choice of qubits they act on. The diffusion operators are able to reach each of the states need to be chosen so if one of them acts on a subset of states in such a way that the output belongs to the same subset, then there is another operator, generating the output outside of this subset when acting on the input state in the set.

In various examples, the oracle may or may not mark the selected element with a phase change, or may or may not code the result to an additional working (ancilla) qubit, providing the way to measure the result, which in turn can be used to execute other parts of the quantum circuit 110 conditionally, based on a measurement result.

The oracle and the diffusion operators can be used in any sequence, and the order of applying these diffusion operators can be optimized to find the partial solution rather than the final one, for example, to be subsequently used with another circuit utilizing the same oracle or a different oracle, such as a simpler oracle. The oracle/diffusion operator sequence can be optimized so a measurement, such as a measurement of an ancillary qubit or other qubit, will allow for conditional execution of subsequent parts of the circuit, for all or nearly all measurement results, so the total probability of success is increased in comparison with just the final measurement. The oracle/diffusion operator sequence can be optimized, for example, to generate shorter circuits with lower success probability than longer ones, resulting in lower expected number of the oracle calls needed to obtain the solution.

In various examples, the diffusion operators can be constructed so the complexity of oracles is reduced around diffusion operators G, by omitting parts of circuits of oracles commuting with G with no change to the result. In accordance with this example, access to the oracle is available, such as the case of oracle testing satisfiability of the assignment of variables in a Boolean satisfiability problem, other satisfiability problem, or other problem were access to the oracle is possible. Scaling of the complexity of the circuit with increased size the database's number of records is no worse than O(Log(N)*sqrt(N)), this can be further optimized on the case-by-case basis, depending on the particular quantum computing problem being solved.

In various examples, the H gates 112, O gates 113, G gates 115 and other quantum logic gates 116 of the quantum circuit 110 can be implemented with one or more processing devices. Each such processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Each such processing device can operate in conjunction with an attached memory and/or an integrated memory element such as classical memory or other memory device, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information.

Note that if the quantum circuit 110 is implemented via more than one processing device, the processing devices may be centrally located (e.g., directly coupled together via a wired and/or wireless bus structure) or may be distributedly located (e.g., cloud computing via indirect coupling via a local area network and/or a wide area network). Further note that if the quantum circuit 110 implements one or more of its gates or other functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, a memory can store, and a processing device can execute, hard coded and/or other operational instructions corresponding to at least some of the steps and/or functions illustrated in one or more of the Figures. Such a memory device or memory element can be tangible memory device or other non-transitory storage medium included in or implemented as an article of manufacture.

Further discussion regarding the operation of the quantum circuit 110, including several optional functions and features are described in conjunction with the figures that follow.

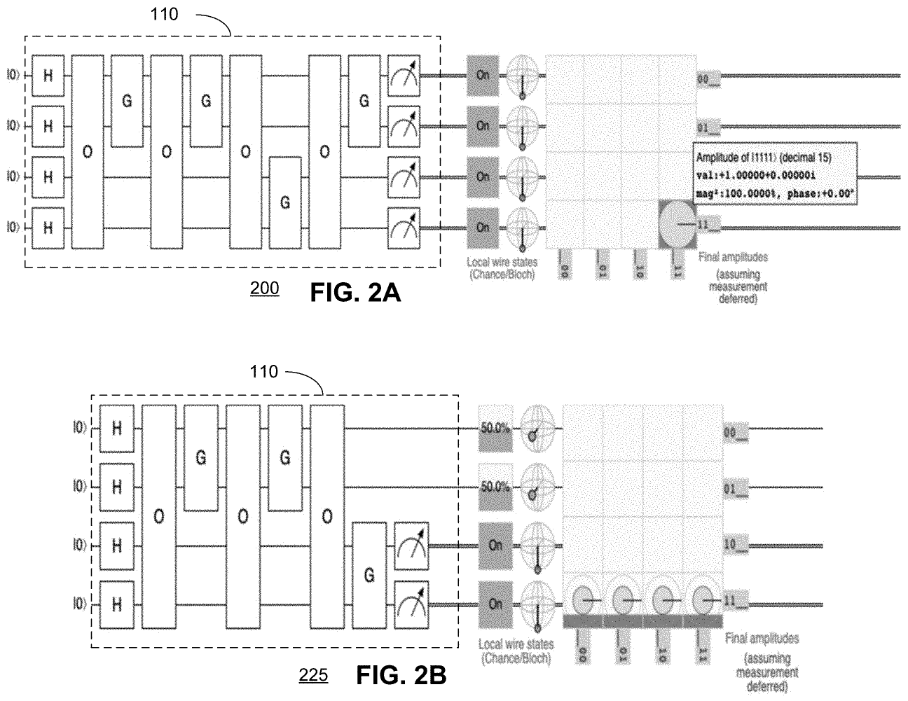

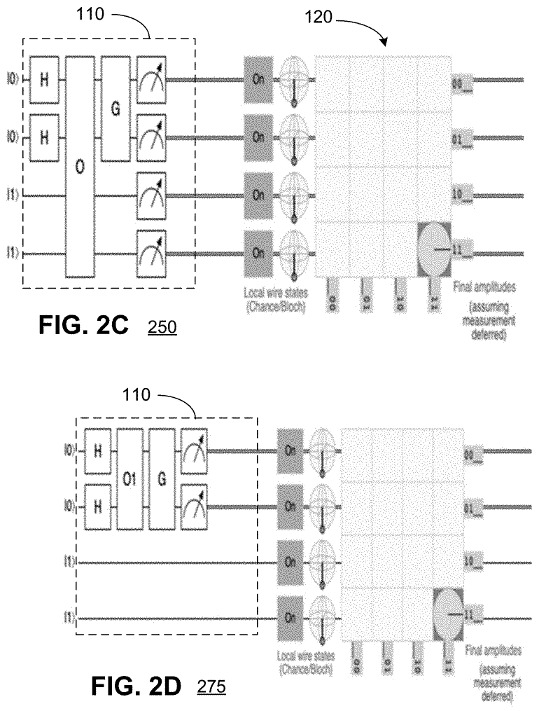

FIGS. 2A-2D are schematic block diagrams 200, 225, 250 and 275 of examples of a quantum circuit 110 in accordance with the present disclosure. In particular, 4-qubit examples are shown. The wire state for each qubit is shown in a Bloch-sphere representation for purposes of illustration. As discussed above, the oracle and the diffusion operators can be used in any sequence and the order of applying them can be optimized to find the partial solution rather than the final one, for example, to be subsequently used with another circuit utilizing the same oracle or a different such as a simpler oracle.

In FIG. 2A, the four qubit states are initialized to zero and four Hadamard gates are employed. There are four oracle calls. The diffusion gates employ two different diffusion operators, a first one on the upper two qubits and a second one on the lower two qubits. The first diffusion operator is applied three times and the second diffusion operator is applied only once. The full quantum circuit 110 yields the desired result with certainty.

In FIG. 2B, the four qubit states are initialized to zero and four Hadamard gates are employed. There are three oracle calls. The diffusion gates employ two different diffusion operators, a first one on the upper two qubits and a second one on the lower two qubits. The first diffusion operator is applied two times and the second diffusion operator is applied only once. The partial circuit of FIG. 2B determines the partial solution. Using partial measurement allows for a division of the circuit into two shorter ones.

In FIG. 2C, the partial solution from FIG. 2B is used in a second circuit for register state initialization. The upper two qubit states are initialized to zero while the lower two are initialized to one. Two Hadamard gates are employed on the upper two qubits. There is only one oracle call. The first diffusion operator is applied only once. Alternatively, the partial solution may be used with a modified oracle, (O1 of FIG. 2D), the operation of which uses the information from the partial solution of FIG. 2B.

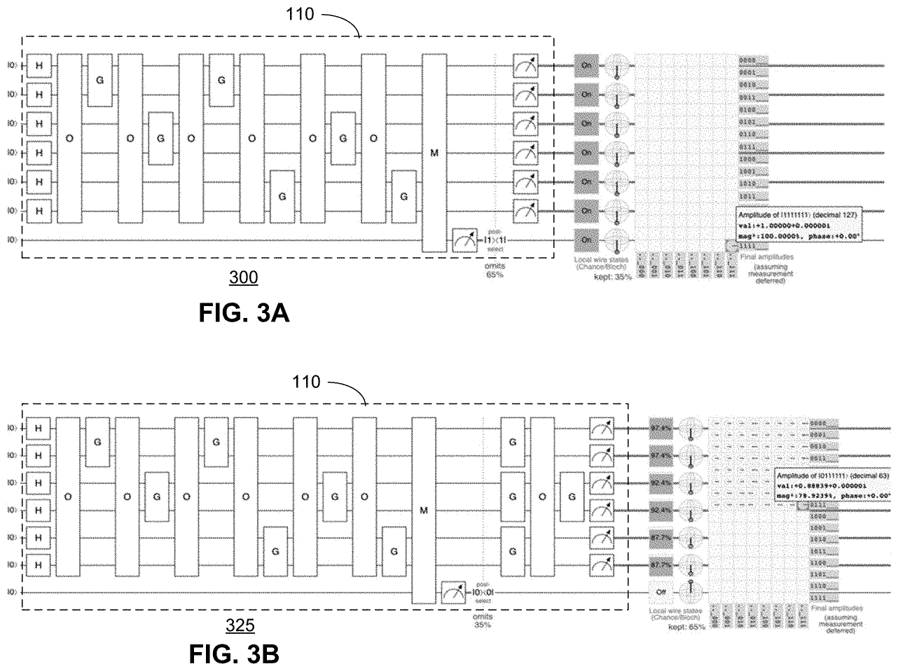

FIGS. 3A-3B are schematic block diagrams 300 and 325 of example of a quantum circuit 110 in accordance with the present disclosure. In particular, a 7-qubit example is shown. As discussed above, the oracle/diffusion operator sequence can be optimized so a measurement of one or more qubits, will allow for conditional execution of subsequent parts of the circuit, for all or nearly all measurement results so the total probability of success is increased in comparison with just the final measurement.

In the example shown, the probability of success is increased by a conditional execution of some gates based on the partial measurement of one qubit. If the measurement after oracle M yields success, measuring the qubits yields the result as shown in FIG. 3A. If the measurement after oracle M yields failure, the measurement had collapsed the state of the register to the superposition not containing the solution and the execution of the gates to the right of the dashed vertical line follows as shown in FIG. 3B. In various examples, this further part may contain more conditional executions, and yields the result with higher probability—i.e., with the total probability of success higher than without the in-circuit measurement.

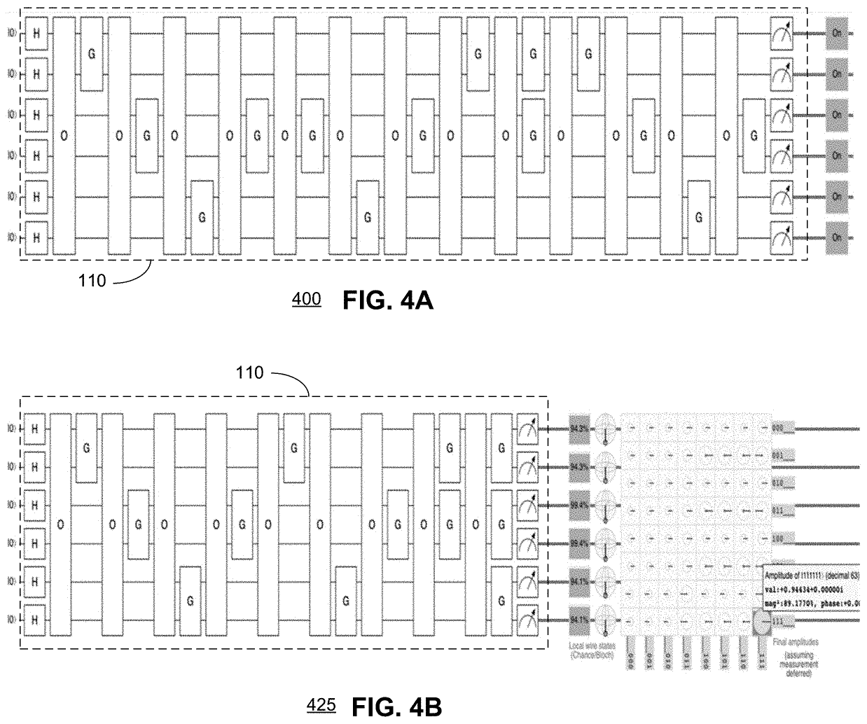

FIGS. 4A-4B are schematic block diagrams 400 and 425 of examples of a quantum circuit 110 in accordance with the present disclosure. In particular, 6-qubit examples are shown. As discussed above, the oracle/diffusion operator sequence can be optimized to generate shorter circuits with lower success probability than longer ones, resulting in lower expected number of the oracle calls needed to obtain the solution.

For any oracle there exists a circuit that has 100% probability (P) of success. FIG. 4A presents a quantum circuit 110 with 13 oracle calls. This results in P=1, since the expected number of calls=13. There are, however, shorter circuits with lower success probability that may result in lower expected number of the oracle calls needed to obtain the solution. FIG. 4B presents a quantum circuit 110 with 9 oracle calls. This results in P=0.89, since the expected number of calls=10.1.

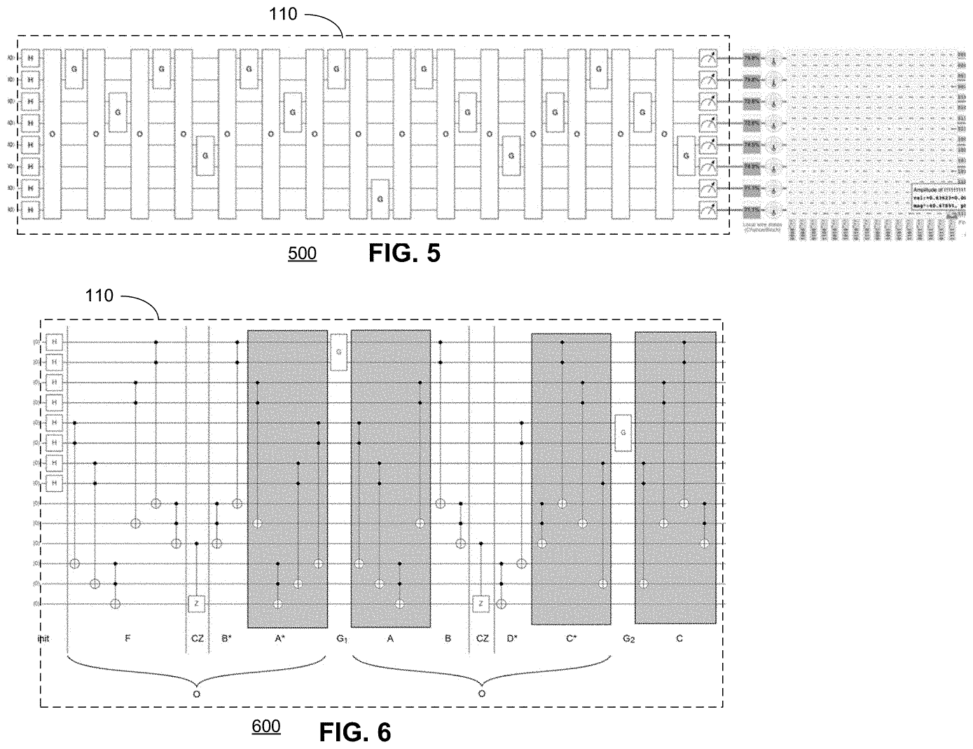

FIG. 5 is a schematic block diagram 500 of an example of a quantum circuit 110 in accordance with the present disclosure. In particular, an 8-qubit example is shown. As discussed above, scaling of the complexity of the quantum circuit 110 with increased size of the number of records in the quantum computing register 120 is no worse than O(Log(N)*sqrt(N)). This is an upper bound and the quantum circuit 110 can be further optimized on the case-by-case basis, depending on the particular quantum computing problem being solved.

FIG. 6 is a schematic block diagram 600 of an example of a quantum circuit 110 in accordance with the present disclosure. In particular, a 14-qubit example is shown. As discussed above, the diffusion operators can be constructed so the complexity of oracles is reduced around diffusion operators G, by omitting parts of circuits of oracle gates commuting with G with no change to the result. In the example shown, grayed-out parts of oracle gate around the diffusion operators G can be omitted. The choice of A, B, C, D, . . . can be adapted depending on the particular operators used. The diffusion operators used between consecutive oracle calls may or may not be different and may or may not use different sets of qubits.

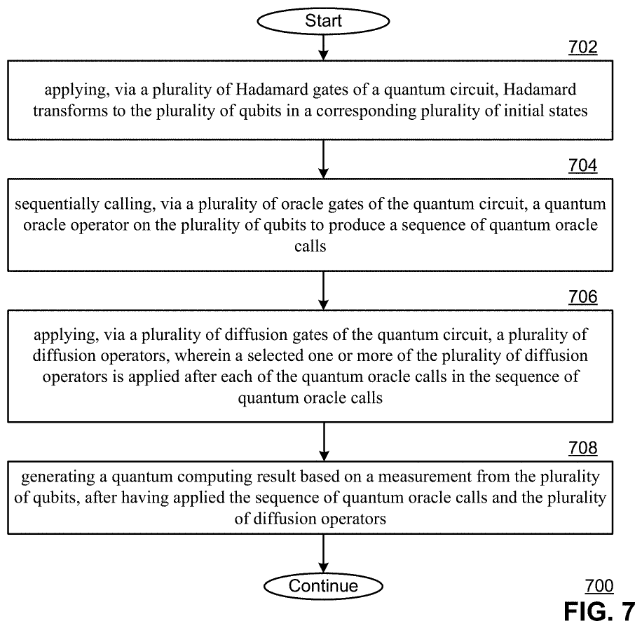

FIG. 7 is a flow diagram 700 of an example of a method in accordance with the present disclosure. In particular, a method is presented for use with one or more functions and features described in conjunctions with FIGS. 1-6. Step 702 includes applying, via a plurality of Hadamard gates of a quantum circuit, Hadamard transforms to the plurality of qubits in a corresponding plurality of initial states. Step 704 includes sequentially calling, via a plurality of oracle gates of the quantum circuit, a quantum oracle operator on the plurality of qubits to produce a sequence of quantum oracle calls. Step 706 includes applying, via a plurality of diffusion gates of the quantum circuit, a plurality of diffusion operators, wherein a selected one or more of the plurality of diffusion operators is applied after each of the quantum oracle calls in the sequence of oracle calls. Step 708 includes generating a quantum computing result based on a measurement from the plurality of qubits, after having applied the sequence of oracle calls and the plurality of diffusion operators.

In various examples, each of the plurality of diffusion operators operates on a unique non-zero proper subset of the plurality of qubits. Further, the unique non-zero proper subset of the plurality of qubits can include two or more neighboring qubits of the plurality of qubits. Furthermore, the diffusion operators may or may not act on the same qubits and may or may not be identical up to the choice of qubits they act on. The diffusion operators are able to reach each of the states need to be chosen so if one of them acts on a subset of states in such a way that the output belongs to the same subset, then there is another operator, generating the output outside of this subset when acting on the input state in the set.

As discussed above, the oracle may or may not mark the selected element with a phase change, or may or may not code the result to an additional working qubit, providing the way to measure the result, which in turn can be used to execute other parts of the quantum circuit 110 conditionally, based on a measurement result.

As discussed above, the oracle and the diffusion operators can be used in any sequence, and the order of applying these diffusion operators can be optimized to find the partial solution rather than the final one, for example, to be subsequently used with another circuit utilizing the same oracle or a different oracle, such as a simpler oracle. The oracle/diffusion operator sequence can be optimized so a measurement, such as a measurement of an ancillary qubit or other qubit, will allow for conditional execution of subsequent parts of the circuit, for all or nearly all measurement results, so the total probability of success is increased in comparison with just the final measurement. The oracle/diffusion operator sequence can be optimized, for example, to generate shorter circuits with lower success probability than longer ones, resulting in lower expected number of the oracle calls needed to obtain the solution.

As discussed above, the diffusion operators can be constructed so the complexity of oracles is reduced around particular diffusion operators G, by omitting parts of circuits of oracles commuting with G with no change to the result. Scaling of the complexity of the circuit with increased size the database's number of records is no worse than O(Log(N)*sqrt(N)), this can be further optimized on the case-by-case basis, depending on the particular quantum computing problem being solved.

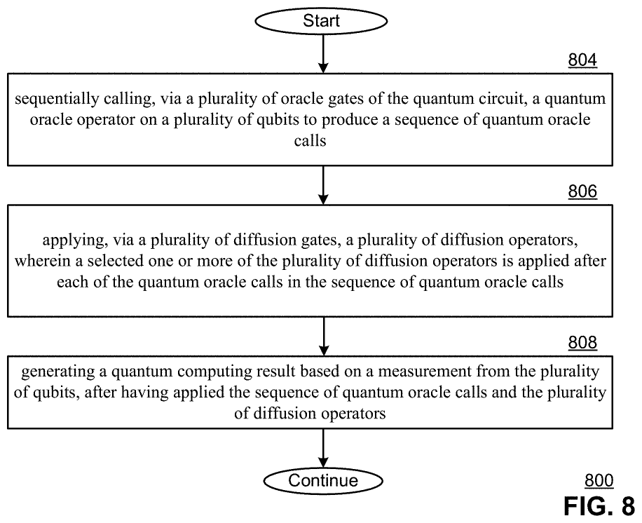

FIG. 8 is a flow diagram 800 of an example of a method in accordance with the present disclosure. In particular, a method is presented for use with one or more functions and features described in conjunctions with FIGS. 1-7. Step 804 includes sequentially calling, via a plurality of oracle gates of a quantum circuit, a quantum oracle operator on a plurality of qubits to produce a sequence of quantum oracle calls. Step 806 includes applying, via a plurality of diffusion gates of the quantum circuit, a plurality of diffusion operators, wherein a selected one or more of the plurality of diffusion operators is applied after each of the quantum oracle calls in the sequence of oracle calls. Step 808 includes generating a quantum computing result based on a measurement from the plurality of qubits, after having applied the sequence of oracle calls and the plurality of diffusion operators.

In various examples, each of the plurality of qubits is initialized to a corresponding initial state and the method further comprises applying, via a plurality of Hadamard gates of the quantum circuit, Hadamard transforms to the plurality of qubits or Hadamard transforms to only a subset of the plurality of qubits.

In various examples, each of the plurality of diffusion operators operates on a unique non-zero proper subset of the plurality of qubits. The unique non-zero proper subset of the plurality of qubits can includes two or more neighboring qubits of the plurality of qubits. At least one of the plurality of diffusion operators operates on each of the plurality of qubits.

In various examples, the quantum oracle codes a result to an ancilla qubit. The ancilla qubit can be used to execute other parts of the quantum circuit conditionally, based on the measurement. The quantum computing result can be a partial solution and the plurality of diffusion operators can be optimized to generate the partial solution. The partial solution can subsequently be used in another quantum circuit that generates a full solution based on one of: the quantum oracle operator or a different quantum oracle operator.

As has been noted that the quantum circuits described herein can be used to generate quantum search results for unstructured database searches. Several examples are presented in conjunction with Appendix I.

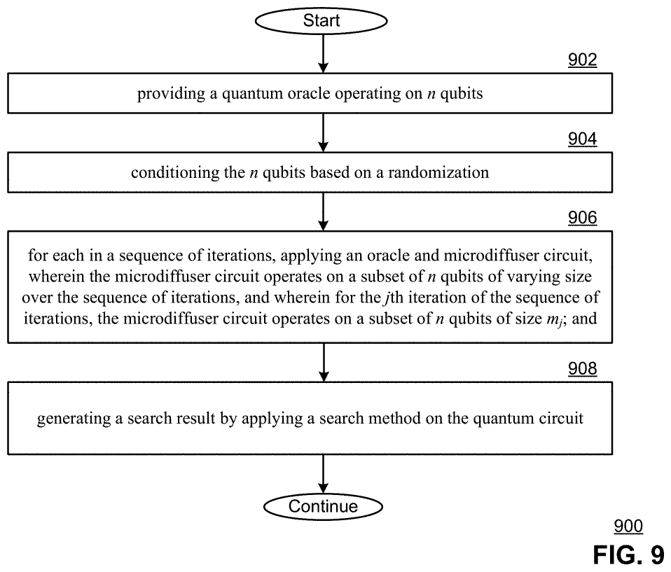

FIG. 9 is a flow diagram 900 of an example of a method in accordance with the present disclosure. In particular, a method is presented for use with one or more functions and features described in conjunctions with FIGS. 1-8. Step 902 includes providing a quantum oracle operating on n qubits. Step 904 includes conditioning the n qubits based on a randomization. Step 906 includes, for each in a sequence of iterations, applying an oracle and microdiffuser circuit, wherein the microdiffuser circuit operates on a subset of n qubits of varying size over the sequence of iterations, and wherein for the jth iteration of the sequence of iterations, the microdiffuser circuit operates on a subset of n qubits of size mⱼ. Step 908 includes generating a search result by applying a search method on the quantum circuit.

In addition or in the alternative, the randomization is one of: a randomization of an ordering of the n qubits; or a randomization of a grouping of the n qubits. In addition or in the alternative, the search method can include an amplitude amplification technique and the search result.

Consider the following example. Suppose we need a password to open a locked door. The only thing we know is that the password is a sequence of zeros and ones, consisting of 10 characters, for example: 1001010000. Without going into the details, the “non-quantum” way to “search” for this unknown sequence, is to check all the possible sequences one-by-one, and there are 2\hat{ }10=1024 of them. The Grover algorithm provides a “quantum” way to search, and roughly speaking it needs only square-root-as-much “attempts” as the classical algorithm, by this I mean it needs roughly sqrt(1024)=32 “attempts” to find the sequence. Using this example, we would say that Grover's algorithm performs a “search” on the “standard search space”, and by “standard search space” we simply mean “all those 1024 possible sequences of zeros and ones”.

Consider however, we have been provided some additional information about the password, such as “there are exactly 3 occurrences of digit 1 in the password”. There is an obvious way how this helps the “non-quantum” way: one would only check the sequences that contain exactly three occurrences of digit 1. There are “10 choose 3”=120 sequences which satisfy this additional constraint. So, as one would expect, the additional knowledge improves the “non-quantum” situation, as it cuts down from 1024 to 120 “attempts” needed. To again make our language clear, we would say this is an example of “n choose k search”, and that we are searching through a “nonstandard search space” which is in this case “all the 0-1 sequences satisfying the additional constraint of containing exactly three 1s”.

Consider the following example and application of one or more of these circuits and techniques. In particular, we will describe a technique of quantum search for an unknown n-bit word or words x ϵ{0, 1)}ⁿ where it is known that x-es have precisely k bits ON and the remaining ones are OFF. As common in quantum computing, we assume that we have an oracle for x-es (let's say that they form some set, possibly with single element, and call this set X), which we will denote by O_{X}.

Definition 1. An oracle O_{X} is a quantum circuit acting on n qubits that has the property

$${O}_{X} \vert j 〉 = \{ \begin{matrix}\vert j 〉 & if j ∉ X , \\ - \vert j 〉 & if j ∈ X .\end{matrix}$$

So, a priori, we are looking for some among

$$( \begin{matrix}n \\ k\end{matrix} )$$

elements.
Based on this, this problem can be called the “n choose k search” which can, for example, be solved using one or more of the techniques and/or circuits previously described and presented in Appendix I.

In particular, the following construction allows for such an efficient search. First, randomize the ordering of wires that serve as input and output for the oracle. There are n wires that serve as input, and we want to make sure that target elements do not have any special form. Other constructions are also possible, some of them may not rely on randomizing the wire order but instead achieve a similar goal by randomizing the choice of assignment of qubits into groups, wherein our algorithm will be applied on consecutive prefixes of groups of qubits.

Definition 2. Let s̅=(s₁, s₂, . . . , sᵣ) be a sequence of positive integers, where n=Σⱼ₌₁^{r}sⱼ. Each prefix sum of the sequence sⱼ will be used as the size of a microdiffusion operator in our circuit, and for different choices of their length we will obtain search algorithms with different complexities. For example sⱼ for j<r, can be equal to ┌(log(|X|+1)┐j while sᵣ would act to fill the expression sum to n if it cannot be set to ┌log(|X|+1)┐r due to expression being larger than n. Given an oracle O on a space it choose k we define the circuit Kⱼ inductively as follows

$${K}_{j} = \{ \begin{matrix}{Id}_{n} & if j = 0 \\ {K}_{j - 1} \cdot {G}_{k , {s}_{1} + {s}_{2} + … {s}_{j} ,}^{n} \cdot {K}_{j - 1}^{†} \cdot O \cdot {K}_{j - 1} & if j > 0\end{matrix}$$

Next, we can apply a search method, such as the amplitude amplification method, on the circuit Kᵣ. This methodology has been described in Gilles Brassard, Peter Hoyer, Michele Mosca, and Alain Tapp, Quantum amplitude amplification and estimation, Contemporary Mathematics, 305:53-74, 2002. This is one search method (among many similar ones) that end in a successful search. Furthermore, by using microdiffusion operators we obtain more possibilities for gate optimization as explained in the “partial uncompute” section of Appendix I.

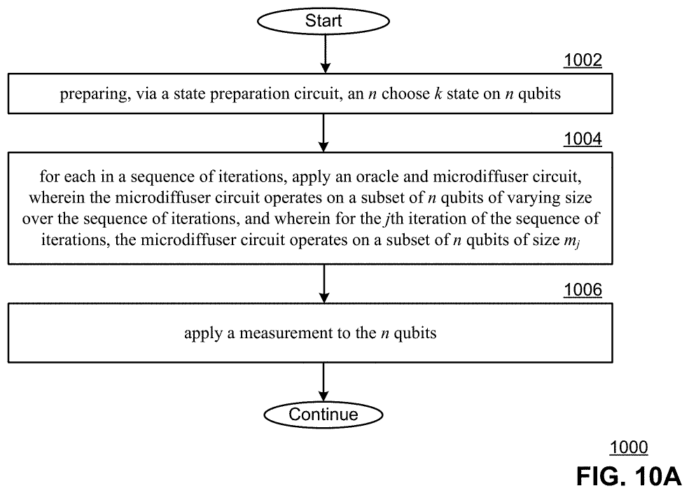

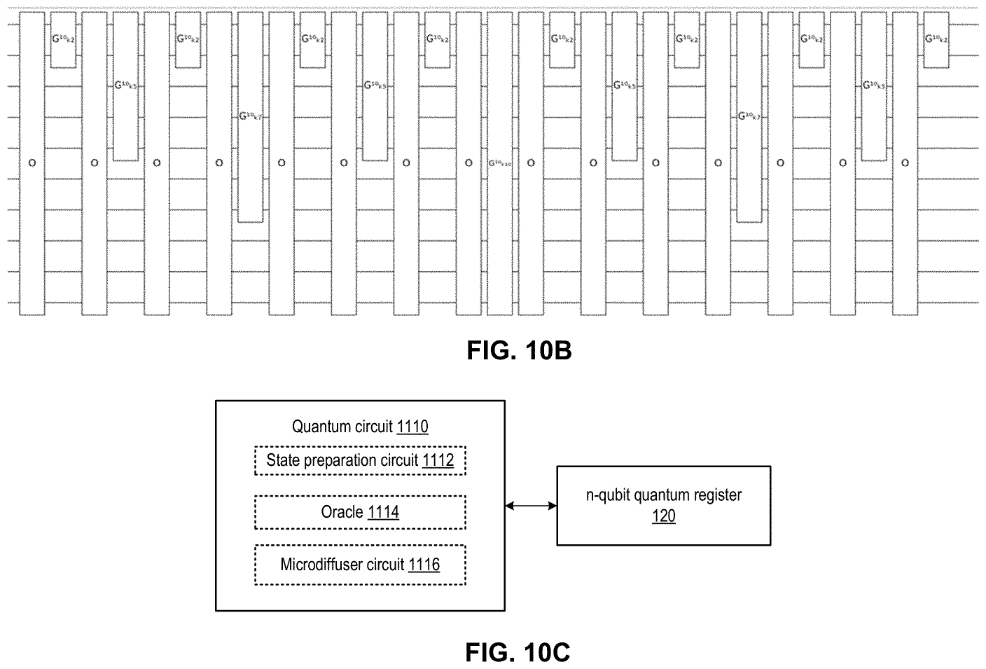

FIG. 10A is a flow diagram 1000 of an example of a method in accordance with the present disclosure. In particular, a method is presented for use with one or more functions and features described in conjunctions with FIGS. 1-9. In particular, a method is presented for use with one or more functions and features described in conjunctions with FIGS. 1-9. Step 1002 includes preparing, via a state preparation circuit, an n choose k state on n qubits. Step 1004 includes, for each in a sequence of iterations, apply an oracle and microdiffuser circuit, wherein the microdiffuser circuit operates on a subset of n qubits of varying size over the sequence of iterations, and wherein for the jth iteration of the sequence of iterations, the microdiffuser circuit operates on a subset of n qubits of size mⱼ. Step 1006 includes applying a measurement to the n qubits.

In addition or in the alternative, the microdiffuser circuit operates on the subset of n qubits of size mⱼ and further on one or more ancillas.

In addition or in the alternative, the conditioning circuit operates further on the one or more ancillas.

In addition or in the alternative, the measurement of the n qubits generates a search result that resolves an n-bit word by determining k bits of the n-bit word that are ON and n-k bits of the n-bit word that are OFF.

In addition or in the alternative, the method further comprises conditioning the n qubits based on a randomization.

In addition or in the alternative, the randomization is one of: a randomization of an ordering of the n qubits; or a randomization of a grouping of the n qubits.

In addition or in the alternative, the state preparation circuit operates on n data qubits (data₀ . . . dataₙ₋₁) and k+1 counter qubits (ctr₀ . . . ctrₖ), where n>1 and n≥k, and wherein the state preparation circuit includes: an X gate applied to ctrₖ; and an auxiliary quantum circuit, Cₖⁿ, that operates on the n data qubits (data₀ . . . dataₙ₋₁) and the k+1 counter qubits (ctr₀ . . . ctrₖ).

In addition or in the alternative, the auxiliary quantum circuit Cₖⁿ, is generated by: providing an auxiliary quantum circuit C₁¹; recursively constructing Cₖⁿ by: for j=1 . . . k, applying an

$$RY ( 2 arccos \sqrt{\frac{n - j}{n}} )$$

gate on data₀ controlled on the jth of the k+1 counter qubits; controlled on data₀, decrementing the counter register; and applying C_{min(n-1,k)}ⁿ⁻¹ on qubits data₀ . . . dataₙ₋₁, and ctr₀ . . . ctr_{min(n-1,k)}.

In addition or in the alternative, the microdiffuser circuit is a microdiffuser circuit, G_{k m}ⁿ, that operates on m data qubits and j₁+1 ancillas, where n> m and j₁=min(m,k), and wherein the microdiffuser circuit comprises: a first auxiliary quantum circuit, (Cⱼ₁^{m})^{†} that operates on the m data qubits (data₀ . . . dataₙ₋₁) and the j₁+1 ancillas; a first plurality of X gates applied to the m data qubits after operation of the first auxiliary quantum circuit; and a controlled Z gate applied to one of the m data qubits and controlled by m−1 remaining data qubits after operation of the first plurality of X gates.

In addition or in the alternative, the microdiffuser circuit, G_{k,m}ⁿ, further includes: a second plurality of X gates applied to the m data qubits after operation of the controlled Z gate; and a second auxiliary quantum circuit, (Cⱼ₁^{m}) that operates on the m data qubits (data₀ . . . dataₙ₋₁) after operation of the second plurality of X gates and the j₁+1 ancillas after operation of the first auxiliary quantum circuit.

FIG. 10C is a schematic block diagram of an example of a quantum circuit in accordance with the present disclosure. In particular, a quantum circuit 1110 is presented that includes a state preparation circuit 1112, that prepares an n choose k state on n qubits, for example, of an n-qubit quantum register 120. The quantum circuit 1110 also includes an oracle 1114 and a microdiffuser circuit 1116. For each in a sequence of iterations, the oracle and the microdiffuser circuit are applied, wherein the microdiffuser circuit operates on a subset of n qubits of varying size over the sequence of iterations, wherein for the jth iteration of the sequence of iterations, the microdiffuser circuit operates on a subset of n qubits of size mⱼ, and wherein a measurement is applied to the n qubits.

In addition or in the alternative, the microdiffuser circuit operates on the subset of n qubits of size mⱼ and further on one or more ancillas.

In addition or in the alternative, the conditioning circuit operates further on the one or more ancillas.

In addition or in the alternative, the measurement of the n qubits generates a search result that resolves an n-bit word by determining k bits of the n-bit word that are ON and n-k bits of the n-bit word that are OFF.

In addition or in the alternative, the method further comprises conditioning the n qubits based on a randomization.

In addition or in the alternative, the randomization is one of: a randomization of an ordering of the n qubits; or a randomization of a grouping of the n qubits.

In addition or in the alternative, the state preparation circuit operates on n data qubits (data₀ . . . dataₙ₋₁) and k+1 counter qubits (ctr₀ . . . ctrₖ), where n>1 and n≥k, and wherein the state preparation circuit includes: an X gate applied to ctrₖ; and an auxiliary quantum circuit, Cₖⁿ, that operates on the n data qubits (data₀ . . . dataₙ₋₁) and the k+1 counter qubits (ctr₀ . . . ctrₖ).

In addition or in the alternative, the auxiliary quantum circuit Cₖⁿ, is generated by: providing an auxiliary quantum circuit C₁¹; recursively constructing Cₖⁿ by: for j=1 . . . k, applying an

$$RY ( 2 arccos \sqrt{\frac{n - j}{n}} )$$

gate on data₀ controlled on the jth of the k+1 counter qubits; controlled on data₀, decrementing the counter register; and applying C_{min(n-1,k)}ⁿ⁻¹ on qubits data₀ . . . dataₙ₋₁, and ctr₀ . . . ctr_{min(n-1, k)}.

In addition or in the alternative, the microdiffuser circuit is a microdiffuser circuit, G_{k,m}ⁿ, that operates on m data qubits and j₁+1 ancillas, where n> m and j₁=_{min(m,k)}, and wherein the microdiffuser circuit comprises: a first auxiliary quantum circuit, (Cⱼ₁^{m})^{†} that operates on the m data qubits (data₀ . . . dataₙ₋₁) and the ⱼ₁+1 ancillas; a first plurality of X gates applied to the m data qubits after operation of the first auxiliary quantum circuit; and a controlled Z gate applied to one of the m data qubits and controlled by m−1 remaining data qubits after operation of the first plurality of X gates.

In addition or in the alternative, the microdiffuser circuit, G_{k,m}ⁿ, further includes: a second plurality of X gates applied to the m data qubits after operation of the controlled Z gate; and a second auxiliary quantum circuit, (Cⱼ₁^{m}) that operates on the m data qubits (data₀ . . . dataₙ₋₁) after operation of the second plurality of X gates and the j₁+1 ancillas after operation of the first auxiliary quantum circuit.

In various examples, as discussed above, the microdiffuser circuit operates on the subset of n qubits of size mⱼ and further on one or more ancillas. Furthermore, the conditioning circuit can also operate on the one or more ancillas. The method can further include conditioning the n qubits based on a randomization. In various examples, the randomization is one of: a randomization of an ordering of the n qubits; or a randomization of a grouping of the n qubits. The search method can include an amplitude amplification technique and the search result can resolve an n-bit word by determining k of the n bits that are ON (e.g., “1”) and n-k bits of the n bits that are OFF (e.g., “0”).

Consider the following example and method for constructing such quantum circuits.

Definition 3. The n choose k state is the following n-qubit quantum state:

$$\vert nCk 〉 = \frac{1}{\sqrt{( \begin{matrix}n \\ k\end{matrix} )}} {\sum }_{j} \vert j 〉 ,$$

where j ranges over all words with k bits ON, For example,

$$\vert 4 C 2 〉 = \frac{1}{\sqrt{6}} ( \vert 0011 〉 + \vert 0101 〉 + \vert 1001 〉 + \vert 1100 〉 + \vert 1010 〉 + \vert 0110 〉 ) .$$

A quantum circuit can be constructed as follows:
(1) Prepare the |nCN [symbol] state.
(2) For a number of iterations, apply the oracle O_{X} and G_{k,m}ⁿ—a microdifuser of size m for n choose k search. The number of iterations, size of the microdiffuser in each iteration, and the choice of qubits on which the microdiffuser will be applied, are important for the success of the algorithm. The circuit Kᵣ presented in the previous section showcases one viable choice (among many) of those parameters. However, they are not the focus of this document, and we will not cover those in detail here.
   Definition 4. A microdiffuser G_{k,m}ⁿ is a circuit acting on m qubits (and possibly some ancillas), satisfying the following property: let us write Vⱼ for the (ⱼ^{m})-dimensional linear space spanned by all m-length words with j bits ON. Set j₀:=max(0,m+k−n), j₁=min(m, k). Then, G_{k,m}ⁿ has to satisfy

G_{k,m}ⁿ=1−2|mCj [symbol] [symbol] mCj| restricted to subspace Vⱼ, for j₀≤j≤j₁ (1)

As usual in quantum computation, the global phase is irrelevant as well. To make matters more understandable, we started out with the microdiffusers which had the following matrix representation:

$$\overline{{G}_{m}} = {\prod }_{j = 0}^{m} ( I - 2 \vert mCj 〉 〈 mCj \vert ) = I - 2 {\sum }_{j = 0}^{m} \vert mCj 〉 〈 mCj \vert .$$

The intuition is that G̅ₘ̅ “mixes” states with the same number of ON bits. Then, one can notice that, when considering particular n, k, certain parts of G̅ₘ̅ will never be used. This way, we arrived at the definition of G_{k,m}ⁿ.
(3) Finally, measure all the computational qubits. The result of the measurement, with high probability, will be equal to x.

These steps leave a large degree of freedom. There are many ways to devise the state preparation and microdiffuser circuits. Therefore, it is desirable to look for implementations that are as efficient as possible. And, of course, the approaches described herein, including the method of FIG. 9, are not limited to the n choose k space but can likewise be applied, for example, to other nonstandard search spaces such as subsets of a fixed cardinality. The only limiting factor in controlling the way a search space behaves is with respect to the prefixes. Other examples of what this “additional information” and “search space” include as presented below.
An information that two consecutive l's never appear in the sequence. We call this “Fibonacci search space”.
An information that the sequence encodes a “well-formed parentheses expression”. Here's what we mean: first, instead of two symbols 0 and 1, we use the two symbols (and). A “well-formed parentheses expression” is something that looks like this:
   (( ))( ) or
   ( ) ( ) ( ) ( ),
   and a sequence that looks like this ( )))((is not well-formed. Formally, a sequence of parentheses is well-formed if [1] on any prefix there is always no less “(“than”)”, [2] in total, there is the same number of both “(“and”)”. We call this “well-formed parentheses search space”.

In each case, this additional information can be incorporated into the “quantum” version of the problem to obtain a speedup (compared to the Grover-without-any-additional-information that solves the problem in sqrt(1024) “attempts”). As a result, various examples described herein improve the technology of quantum computing by providing an improved to Grover's algorithm that applies quantum searches through a nonstandard search space using microdiffuser techniques. These search methods have some general features independent of the specific search space, and some features that depend on the specific search space. To elaborate:
Regardless of the specific search space, the whole method relies on certain quantum subcircuits, which can be called “state preparation circuits” and/or “microdiffusion circuits”.
Those parts, together with oracles, make up the whole circuit. What remains is the choice of [1] number of microdiffusers, [2] choosing size of each microdiffuser. There is a variety of designs that work, including the techniques previously described. These designs can be used regardless of the specific search space. In particular, a further example is presented in conjunction with FIG. 10B that illustrates one microdiffuser layouts that works, in general, for the quantum search on nonstandard spaces. FIG. 5 shows a very similar circuit—the only difference is that the microdiffusers “go all the way up” to the top (e.g. always operate on the topmost x qubits, where x is two in this particular example).
Consequently, the “state preparation circuits” and “microdiffusion circuits” can be designed on a case-by-case basis, depending, for example, on the search space.

Additionally, the technology of quantum computing has been approved by the introductions of the following:
“randomization”: Our use of micro-diffusers causes some complications. Namely, the search method works very well for most sequences, but it does slightly worse for some “bad” sequences in the search space. For example, the “bad” sequences for n-choose-k search are the one which look “sorted” i.e. have most of the 0's in front and 1's in the back, something like: 0000001011 or 0000000111. For example, the randomization technique can mean:
   1. Choose, at random, some permutation of the n qubits.
   2. Before and after every oracle, we shuffle the order of qubits according to this permutation.
   3. The quantum search method will now find the unknown sequence, with the caveat that the result is shuffled. So as the very last step of the method (after the quantum computation is done), we undo the shuffling (randomization) and we get the final result.
      It should be noted that the “additional information” of the search space is not “destroyed” by the randomization procedure. To continue the example, let's say we are talking about n-choose-k search, where n=10, k=3. So the unknown sequence might look like this: 0000001011. After we shuffle, it looks different: 1000101000. But the number of 1's is unchanged by shuffling, the new sequence still satisfies the “there are exactly three 1's” information. For other search spaces, this might not work, for example in the “well-formed parentheses” search space this breaks down: “( ) ( )(( ))” is well-formed, but after shuffling the parentheses around we could get “)( )( )( )(” which is not well-formed.

So to sum up: the randomization is an improvement that's generally desirable, regardless of the specific search space. Depending on the specific search space, the randomization might be applicable or not. Depending on the specific search space, a different method of randomization might be applicable (here by “different” I mean: instead of “shuffling” for example we “flip” all the 0's into 1's and vice versa. Then this “flipping” would be again performed before and after every oracle, and finally after running the whole quantum computation we would “unflip” the result to get the final answer.)

Consider the further examples that follow where the particular quantum circuits that make up the overall circuit can be constructed as follows.

We outline the general idea underlying our circuits here. We will use a register which we name counter, that encodes an integer between 0 and k inclusively; let us write |j [symbol] _{ctr} or state that represents the integer j (dearly, one can imagine many such encodings; we discuss particular choices later). For the n choose k state preparation, we are looking for any circuit SPₖⁿ that has the property SPₖⁿ|0 . . . 0 [symbol] =|nCk). Let us do a bit more, namely, we will produce a circuit Cₖⁿ that has the property

Cₖⁿ|0 . . . 0 [symbol] |j) [symbol] _{ctr}=|nCj [symbol] |0 [symbol] _{ctr} for 0≤j≤k. (2)

Now, the state preparation circuit SPₖⁿ can be implemented simply by:

(S1) setting up the state |k [symbol] _{ctr} on ancillas,

(S2) applying circuit Cₖⁿ.

To construct the circuit Cₖⁿ, we notice the folkowing identity:

$$\vert nCk 〉 = \sqrt{\frac{k}{n}} \vert 1 〉 ⊗ \vert ( n - 1 ) C ( k - 1 ) ) + \sqrt{\frac{n - k}{n}} \vert 0 〉 ⊗ \vert ) ( n - 1 ) Ck ) .$$

We will denote the data qubits by data₀, . . . dataₙ₋₁. The identity above allows us to implement Cₖⁿ recursively:

(C1) For each 0≤j≤k, controlled on the counter state being |j [symbol] _{ctr}, apply

$$RY ( 2 arccos \sqrt{\frac{n - j}{n}} )$$

on data₀.

[symbol]

(C2) Controlled on data₀, decrement the value stored in the counter by 1. ¹By RY gate we mean the standard 1-qubit gate that is described by unitary matrix:

$$[ RY ( θ ) = [ \begin{matrix}cos ( θ / 2 ) & - sin ( θ / 2 ) \\ sin ( θ / 2 ) & cos ( θ / 2 )\end{matrix} ] , which means that RY ( 2 arccos \sqrt{\frac{n - j}{n}} ) ] = [ \begin{matrix}\sqrt{\frac{n - j}{n}} & - \sqrt{\frac{j}{n}} \\ \sqrt{\frac{j}{n}} & \sqrt{\frac{n - j}{n}}\end{matrix} ] .$$

(C3) Apply C_{min(n-1,k)}ⁿ⁻¹ to the qubits data₁, . . . dataₙ₋₁ and the counter register. To end the recurrence, we just need an empty circuit C₀⁰.

Finally, we deal with the microdiffuser G_{k,m}ⁿ. Once again we define j₁=min(m, k). Suppose that we can implement easily the unitary

$$R = \text{?}$$

$$\text{?} \text{indicates text missing or illegible when filed}$$

Then, the property ( [symbol] ) of Cⱼᵢ^{m} implies that

$$\text{?}$$

$$\text{?} \text{indicates text missing or illegible when filed}$$

The reader may verify that this unitary satisfies the microdiffuser condition [symbol] . Thus, the microdiffuser G_{n,k}^{m} may be implemented by

(G1) applying (Cⱼ₁^{m})^{†},

(G2) applying R,

(G3) applying Cⱼ₁^{m}.

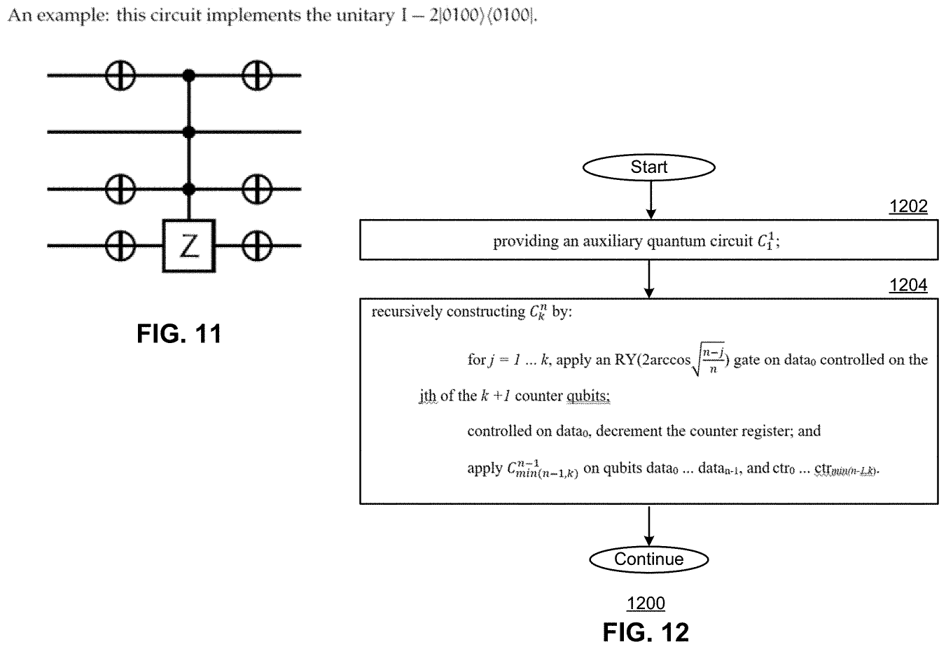

In the description that follows, we present some concrete implementations, where the state |j′ [symbol] . is simply an element of the computational basis; the unitary R is then easily implemented using multiply-controlled CZ gates and some X gates as shown in FIG. 11.

FIG. 12 is a flow diagram 1200 of an example of a method in accordance with the present disclosure for use with one or more functions and features described in conjunctions with FIGS. 1-11. In particular, a method of generating an auxiliary quantum circuit, Cₖⁿ, is presented that operates on n data qubits (data₀ . . . dataₙ₋₁) and k+1 counter qubits (ctr₀ . . . ctrₖ₊₁) of a counter register, where n>1 and n≥k. Step 1202 includes providing an auxiliary quantum circuit C₁¹.

Step 1204 includes recursively constructing Cₖⁿ by: for j=1 . . . k, applying an

$$RY ( 2 arccos \sqrt{\frac{n - j}{n}} )$$

gate on data₀ controlled on the jth of the k+1 counter qubits; controlled on data₀, decrementing the counter register; and applying C_{min(n-1,k)}ⁿ⁻¹ on qubits data₀ . . . dataₙ₋₁, and ctr₀ . . . ctr_{min(n-1,k)}.

Consider the example that follows.

Auxiliary circuit Cₖⁿ: Fix n≥k≥1. We will describe an auxiliary circuit Cₖⁿ, which acts on n data qubits and k+1 qubits for the counter register. We will denote the data qubits by data₀, . . . dataₙ₋₁, and the counter qubits by ctr₀, ctr₁, . . . ctrₖ. We follow the procedure outlined in the previous chapter. We encode an integer j by setting ctrⱼ to 1 and the remaining qubits of the counter to 0. Formally, we define, for j=0 . . . k, the k+1-qubit state

$$\vert {j}^{′} 〉 = {\vert 00 … 1 … 00 〉}_{\underbrace{k + 1 symbols}}$$

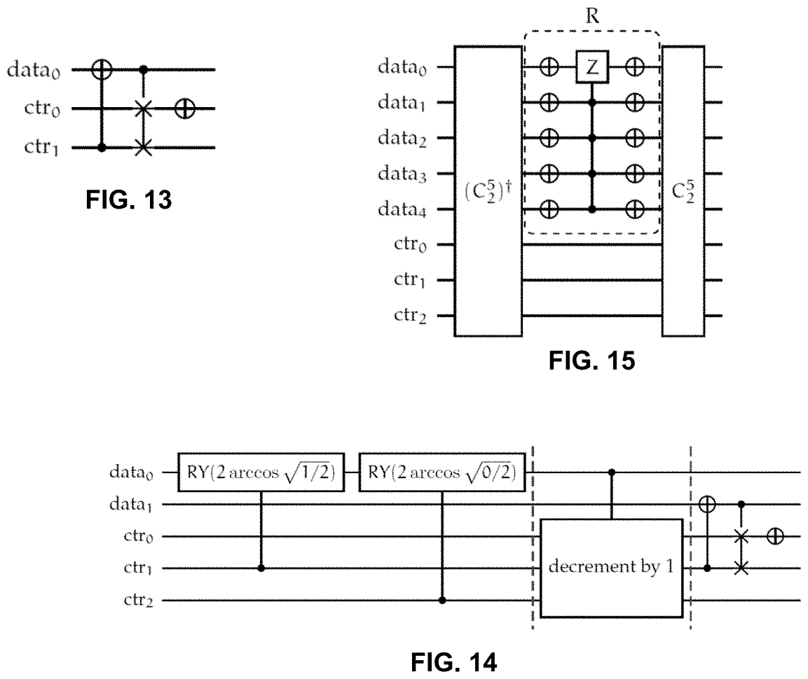

—the only “1” is at the ctrⱼ qubit.
An example of the auxiliary quantum circuit C₁¹ is shown in FIG. 13.

For n≥2, we construct Cₖⁿ recursively, as outlined before:

(C1) For j=1 . . . k, apply

$$RY ( 2 arccos \sqrt{\frac{n - j}{n}} )$$

gate to data₀, controlled on ctrⱼ. In other words, “If the value stored in the counter is equal to j, then perform

$$RY ( 2 arccos \sqrt{\frac{n - j}{n}} )$$

on the data₀ qubit”.

(C2) Controlled on data₀, decrement the value stored in counter register by 1. In this particular encoding, this can be done by a sequence of gates CSWAP(ctr₀, ctr₁), CSWAP(ctr₁, ctr₂), . . . CSWAP(ctrₖ₋₁, ctrₖ), all controlled on data₀ qubit.

(C3) Apply C_{min(n-1,k)}ⁿ⁻¹ on qubits data₁ . . . dataₙ, ctr₀ . . . ctr_{min(n-1,k)}.

A simple computation shows that the Cₙ^{k} circuit contains O(nk) gates.

An example of the auxiliary quantum circuit C₂² is shown in FIG. 14.

In various examples, the state preparation circuit operates on n data qubits (data₀ . . . dataₙ₋₁) and k+1 counter qubits (ctr₀ . . . ctrₖ), where n>1 and n≥k. The state preparation circuit can include an X gate applied to ctrₖ; and an auxiliary quantum circuit, Cₖⁿ, that operates on the n data qubits (data₀ . . . dataₙ₋₁) and the k+1 counter qubits (ctr₀ . . . ctrₖ).

Consider the example that follows.

State preparation circuit |nCk [symbol] : For given parameters n and 0≤(k≤n, the |nCk) state preparation circuit acts on n data qubits and k+1 additional qubits for the counter register. The purpose of this circuit is to transform the initial |0 . . . 0 [symbol] state into state |nCk [symbol] .

This is done as follows

(S1) Apply an X gate to ctrₖ.

(S2) Apply the circuit Cₖⁿ.

Clearly, this state preparation circuit contains [symbol] (nk) gates.

In various examples, a microdiffuser circuit, G_{k,m}ⁿ, operates on m data qubits and j₁+1 ancillas, where n> m and j₁=min(m,k). The microdiffuser circuit comprises: a first auxiliary quantum circuit, (Cⱼ₁^{m})^{†} that operates on the m data qubits (data₀ . . . dataⁿ⁻¹) and the j₁+1 ancillas; a first plurality of X gates applied to the m data qubits after operation of the first auxiliary quantum circuit; a controlled Z gate applied to one of the m data qubits and controlled by m−1 remaining data qubits after operation of the first plurality of X gates; a second plurality of X gates applied to the m data qubits after operation of the controlled Z gate; and a second auxiliary quantum circuit, (Cⱼ₁^{m}) that operates on the m data qubits (data₀ . . . dataₙ₋₁) after operation of the second plurality of X gates and the j₁+1 ancillas after operation of the first auxiliary quantum circuit.

Consider the following example.

Microdiffuser G_{k,m}ⁿ: As previously, we use the notation j₁=min(m,k). The circuit G_{k,m}ⁿ, acting on m data qubits and j₁+1 ancillas, can be constructed as follows.

(G1) Apply (Cⱼ₁^{m})^{†}.

(G2a) Apply X gates on all data qubits.

(G2b) Use any implementation of C^{(#data-1)} Z operator.

(G2c) Apply X gates on all data qubits.

(G3) Apply Cⱼ₁^{m}.

An example of microdiffuser circuit G_{2,5}¹⁰ is shown in FIG. 15. The microdiffuser circuit, G_{k,m}ⁿ contains O(mj₁) gates. It is noted that the circuit labelled R in FIG. 15 corresponds to steps G₂ₐ-G_{2c} and corresponds to the circuit previously described.

The constructions previously described are quite efficient (in terms of gate count) circuits while using k+1 qubits to store one of k+1 values. However, sometimes it is important to lower the number of qubits used for storing numeric values. From that point of view, the design from previous section is somewhat wasteful, as log2(k+1) classical bits suffice to store k+1 different values.

In such cases, the design may be implemented with binary encoding of numbers 0, . . . k on log2(k+1) qubits. In this case:
in (C1), the gates are now controlled by O(log k) qubits, thus the gate count of Cₖⁿ circuit increases to O(nk log k);
in (C2), a circuit decrementing counter register by 1 needs to be implemented; and
the parts (S1) and (G2a-G2c) must be altered accordingly.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provides an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

One or more examples have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more examples are used herein to illustrate one or more aspects, one or more features, one or more concepts, and/or one or more examples. A physical example of an apparatus, an article of manufacture, a machine, and/or of a process may include one or more of the aspects, features, concepts, examples, etc. described with reference to one or more of the examples discussed herein. Further, from figure to figure, the examples may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the examples. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind. While particular combinations of various functions and features of the one or more examples have been expressly described herein, other combinations of these features and functions are likewise possible. The present disclosure is not limited by the particular examples disclosed herein and expressly incorporates these other combinations.

APPENDIX I—Introducing structure to expedite quantum search

We present a novel quantum algorithm for solving the unstructured search problem with one marked element. Our algorithm allows generating quantum circuits that use asymptotically fewer additional quantum gate % than the famous Grover's algorithm and may be successfully executed on NISQ devices. We prove that our algorithm is optimal in the total number of elementary gates up to a multiplicative constant. As many NP-hard problems are, in fact, not unstructured, we also describe the partial uncompute technique which exploits the oracle structure and allows a significant reduction in the number of elementary gates required to find the solution. Combining these results allows us to use an asymptotically smaller number of elementary gates than Grover's algorithm in various applications, keeping the number of queries to the oracle essentially the same. We show how the results can be applied to solve hard combinatorial problems, for example, Unique k-SAT. Additionally, we show how to asymptotically reduce the number of elementary gates required to solve the unstructured search problem with multiple marked elements.

### I. Introduction

In the quantum unstructured search problem the task is to find one marked element out of N elements corresponding to the computational basis. We want to accomplish that by the least possible number of queries to a given phase oracle, the only action of which is changing the signs of the coordinates corresponding to the marked elements. For more details, see section

[symbol]

The celebrated Grover's algorithm [symbol] is one of the main achievements of quantum computing. It locate a marked element using only [symbol] (\sqrt{N}) queries to the oracle and [symbol] (\sqrt{N}log N) additional (i.e. non-oracle) elementary gates Grover's result has been used extensively as a subroutine in many quantum algorithms, for examples see [symbol] We show how to reduce the average number of additional gates per oracle query while keeping the number of oracle queries as close to the optimum as we wish. We alsa prove that our algorithm is optimal up to a multiplicative constant.

### A. Prior Work

Since the invention of Grover's algorithm, there were several attempts to improve it further. In [symbol] the author improves the number of non-oracle quantum gates. Using a simple pattern of small diffusion operators the following results is obtained.

Theorem 1 [symbol] . For every α>2 and any sufficiently large N there exists a quantum algorithm that finds the unique marked element among N with probability tending to 1, using fewer than

$$\frac{π}{4} \sqrt{N} ( \frac{1}{1 - {( {log}_{2} N )}^{2 - α}} )$$

oracle queries and no more than

$$\frac{9}{8} πα \sqrt{N} {log}_{2} {log}_{2} N$$

non-oracle guts.

Later, in [symbol] the authors reduce the number of non-oracle gates even further.

Theorem 2 ( [symbol] ). For any integer r>0 and sufficiently large N of the form N=2ⁿ, there exists a quantum algorithm that finds the unique marked element among N with probability 1, using

$$( \frac{π}{4} + o ( 1 ) ) \sqrt{N}$$

queries and [symbol] (\sqrt{N}log*N) gates. For every ε>0 and sufficiently large N of the form N=2ⁿ, there exists a quantum algorithm that finds the unique marked element among N with probability 1, using

$$\frac{π}{4} \sqrt{N} ( 1 + ε )$$

queries and [symbol] (\sqrt{N}log(log*N)) gates.

In the same paper, the authors raise questions regarding removing the log(log*N) factor in gate complexity, which we answer in the affirmative in Theorem [symbol] and dealing with oracles that mark multiple elements. Note that both aforementioned results assume that the given oracle marks only a single element.

The concept of benefits arising from the use of local diffusion operators has been studied in other papers, e.g.

[symbol]

### B. Our Results

We present an algorithm which uses only [symbol] (\sqrt{N})non-oracle gates while making only [symbol] (\sqrt{N}) oracle queries. Additionally, to remedy the objections against optimizing the average number of additional elementary gates per oracle query mentioned in |2|, we introduce the concept of partial uncompute—a technique that achieves asymptotical improvement in the total number of elementary gates in many combinatorial problems, such as Unique k-SAT (see e g. [symbol] for the definition of Unique k-SAT). The high-level idea of the technique is to utilize the structure of the given oracle and store some intermediate information on ancilla qubits when implementing the oracle. If between two consecutive oracle queries we applied elementary gates only on a small number of qubits, we expect that the most of intermediate information has not changed at all. Leveraging this phenomenon, we can reduce the asymptotic number of gates needed to implement the circuit.

In Grover's algorithm the diffusion operator is applied on [symbol] 69 (log N) qubits, so we cannot benefit from partial uncompute. We need to have an algorithm that on average affects only a small subset of qubits between consecutive oracle queries. To handle this problem we introduce an algorithm for generating quantum circuits that drastically reduces the average number of additional gates. The algorithm can be used to generate circuits that work for any number of qubits and can be potentially implemented on NISQ devices. Moreover, the algorithm improves on the results of [symbol] and |2| and can be summarized as follows.

Theorem 3. Fix any ε ∈ (0, 1), and any N ∈ [symbol] of the form N=2ⁿ Suppose we are given a quantum oracle O operating on a qubits that marks exactly one element. Then there exists a quantum circuit [symbol] which use the oracle O at most

$$( 1 + ε ) \frac{π}{4} \sqrt{N}$$

times and uses at most [symbol] (log(1/2)\sqrt{N}) non-oracle basic gates, which finds the element marked by O with certainty.

It is important to note that the constant hidden by [symbol] 69 notation in Theorem [symbol] is independent of both N and ε. Moreover, any quantum algorithm tackling this problem must perform at least

$$\frac{π}{4} \sqrt{N}$$

oracle calls, see [symbol] .

The algorithm [symbol] can be, in broad strokes, explained as follows. We build a quantum circuit recursively according to some simple rules. The resulting circuit concentrates enough amplitude in the marked element. After that, we apply Amplitude Amplification [symbol] to it. The main idea in [symbol] is to explore small diffusion operators (diffusion operators applied on a small subset of qubits). They are obviously easier to implement than large ones and require fewer elementary gates. Moreover, if they are applied wisely, they can be extremely efficient in concentrating amplitude in the marked element.

If we combine the partial uncompute technique with Theorem [symbol] to solve a Unique k-SAT problem, we get the following corollary.

Corollary 4. Consider the Unique k-SAT problem with n variables and clauses. There exists a quantum circuit that uses [symbol] (e log(e)2^{n/2}/n) total (oracle and non-oracle) gates and solves the problem with certainty.
It worth mentioning that it is a slight improvement over the naïve application of Grover's algorithm to solve the Unique k-SAT problem, because Grover's algorithm requires [symbol] ((n+. e)*2^{n/2}) elementary gates to solve the problem with certainty.

By result of [symbol] , the optimal number of queries to the oracle required for solving unstructured search problem with certainty is

$$\frac{π}{4} \sqrt{N} .$$

We show that the trade-off between the number of oracle queries and non-oracle gates from Theorem [symbol] is optimal up to a constant factor.
Corollary 5. There exists a number δ>0 such that for any ε ∈ (0, 1) and for any quantum circuit [symbol] the following holds. If [symbol] uses at most δlog(1/2)\sqrt{N} non-oracle gates and finds the element marked by O with certainty then [symbol] uses the oracle O at least

$$( 1 + ε ) \frac{π}{4} \sqrt{N}$$

times.

Last but not least, following the approach of [symbol] , we asymptotically reduce the overhead incurred when reducing the unstructured search problem with multiple marked elements to the unstructured search problem with exactly one marked element. We modify the oracle in a classical randomized way so that the modified oracle marks exactly one element with constant probability. This is achieved by randomly choosing an affine hash function that excludes some elements from the search space. If the number of marked elements K is known in advance, we will sample a hash function from such a set so that the expected number of marked elements after combining the oracle with the function is equal to one. We formulate this result as the following theorem.

Theorem 6. Let N ∈ [symbol] be of the form N=2ⁿ. Assume that we are given a phase oracle O that marks K elements, and we know the number k given by k=1+┌log₂ K┐. Then one am find an dement marked by O with probability at last

$$\frac{1}{16}$$

using at most

$$𝒪 ( \sqrt{\frac{N}{K}} )$$

oracle queries and at most

$$𝒪 ( log K \sqrt{\frac{N}{K} )}$$

non-oracle basic gates.

What is more: we can extend this approach to the case when the number of marked elements is unknown by trying different values of K and applying the same algorithm. This can be done in such a way that the number of oracle queries and the average number of additional elementary gates per oracle query are asymptotically the same as in the case of known K.

### C. Further Remarks

While our results describe asymptotic behavior, the techniques used to achieve them are quite practical. As described [symbol] , they may be applicable for achieving the improvements in implementations of unstructured search on existing and near-future NISQ devices. The previous implementations of unstructured search beyond spaces spanned by 3-qubits were unsuccessful [symbol] , perhaps techniques described here can allow searching larger spaces on current hardware.

In section [symbol] we briefly discus the computational model and notation used throughout this paper. In section [symbol] we describe our main algorithm for constructing quantum circuits. Next, in section [symbol] we prove that our algorithm is optimal (up to a constant factor) in the number of additional elementary gates. Later, in section [symbol] we introduce the partial uncompute technique and show an example application to a hard combinatorial problem. Finally, in section [symbol] we proceed to reduce the unstructured search problem with multiple marked elements to the unstructured search problem with one marked element.

### II. Preliminaries

In the unstructured search problem we are given a function ƒ:{0, 1}ⁿ→{0, 1} for some n ∈ [symbol] and we wish to find x ∈ {0, 1}ⁿ such that ƒ(x)=1. We will call such x marked. The function can be evaluated at N points in total, where N=2ⁿ, and the goal is to find a marked element whilst minimizing the total number of evaluations of ƒ. In the quantum version of the problem the function ƒ is given as a phase oracle O, i.e. a unitary transformation given by O|x [symbol] =(−1^{ƒ(x)}|x [symbol] for every computational basis vector |x [symbol] . We still want to query O the least possible number of times to find a marked element. Sometimes this problem is called the database search problem. We use the standard gate model of quantum computations. We assume that our elementary operations are the universal set of quantum gates consisting of CNOT and arbitrary one qubit gates. We will refer to these gates as basic gates. We note that this gate set can simulate any other universal gate set with bounded gate size with at most constant overhead, the details can be found in [symbol] .

In all following equations all operators are to be understood as applied right-to-left (i.e. as in standard operator composition), while in figures the application order is left-to-right, as is the standard when drawing quantum circuits.

Given a positive integer k, the uniform superposition state on k qubits, denoted |uₖ [symbol] , is defined as

$$\vert {u}_{k} 〉 = \frac{1}{{2}^{k / 2}} {\sum }_{k ∈ ( 0 , 1 )} ⋆ \vert b 〉 .$$

We extend this definition to the special case of k=0 by setting |u₀ [symbol] =1. A useful identity which we will use throughout the derivations to come is |uₐ [symbol] |u_{b} [symbol] =|u_{a+b} [symbol] for a,b ∈ [symbol] .

The mixing operator of size k (alternatively also called the diffusion operator, or simply the diffuser), denoted Gₖ, is defined as Gₖ=2|uₖ [symbol] [symbol] uₖ|−Idₖ, where Id_{g} is the identity Matrix of size 2^{b}. From [symbol] we know that we can implement Gₖ using [symbol] (k) basic gates (and this is best possible).

To prove optimality of our results and to define the partial uncompute technique we consider what happens when operators do not act on some subset of qubits. Intuitively, it means that we do not need to use these qubits when implementing this operator using basic gates. We say that a unitary matrix. A operating on n qubits (here denoted (q₁, . . . ,qₙ) does not act on the qubit qₜ if

A=SWAP(qₜ,qₙ)(A′⊗Idₜ)SWAP(qₜ,qₙ)

where A′ is some unitary matrix operating on n−1 qubits, and SWAP(a,b)=CNOT(a,b)(CNOT(b,a) CNOT(a,b). Otherwise we say that A acts on qubit qₜ. We say that operator A may act on qubits qₜ_{₁}, . . . , qₜ_{ₘ}, if it does not act on qubits (q₁, . . . , qₙ)\{qₜ_{₁}, qₜ_{₂}, . . . , qₜ_{ₘ}}

In the proof of Theorem [symbol] we will need the following result from [symbol] , which we will refer to as Amplitude Amplification.

Theorem 7 ( [symbol] , p.7 Theorem 2). Let [symbol] be any quantum algorithm operating on n qubits that uses no measurements, and let ƒ: (0, 1)ⁿ→{0, 1} be any boolean function with a corresponding phase oracle O. Let a be the probability that measuring [symbol] |00 . . . 0) yields |t [symbol] such that ƒ(t)=1, and assume that a ∈ (0, 1), Let 0 ∈ (0, π/2) be such that (sin θ)²=a, and let

$$s = ⌊ \frac{π}{4 θ} ⌋ .$$

Then measuring (− [symbol] F₀ [symbol] ¹O)ⁿ [symbol] |00 . . . 0 [symbol] yields |t [symbol] such that ƒ(t)=1 with probability at least max{1−a, a}, where

$${F}_{0} \vert t 〉 = \{ \begin{matrix}\vert t 〉 & if t \neq 0 \\ - \vert t 〉 , & if t = 0\end{matrix} .$$

Note that this result requires us to know the value of a precisely. However, this is not a problem for us, as we shall later see.

There is a simple corollary one can obtain from the proof of Theorem [symbol] (it is noted as Theorem 4 in [symbol] , however the authors do not make the constants explicit in their formulation). The precise formula one gets for the probability of success when measuring (− [symbol] F₀, [symbol] ^{†}O)^{m} [symbol] |00 . . . 0 [symbol] is in fact equal to sin²{(2m+1)θ). If it were to happen that r=π(4θ) 1/2 was an integer, then we could simply set the number of iterations to r and obtain a solution with certainty. Now it remains to note that we can easily modify [symbol] to lower θ slightly so that the new value of r is indeed an integer. It is important for our results that the number of iterations is in fact bounded

$$⌊ \frac{π}{4 θ} ⌋ + 1 ,$$

which is formulated as the theorem below.

Theorem 8 ( [symbol] , Theorem 4 restated). Let [symbol] be any quantum algorithm operating on n qubits that uses no measurements, and let ƒ: {0, 1}ⁿ→{0, 1} e any boolean function. Let a be the probability that measuring [symbol] |00 . . . 0 [symbol] yields |t [symbol] such that ƒ(t)=1, and assume that a ∈(0, 1). Let θ∈ (0, π/2) be such that {sin θ)²=a.

Then there exists a quantum algorithm that uses [symbol] and [symbol] ^{t} at most

$$⌊ \frac{π}{4 θ} ⌋ + 2$$

times each, which upon measurement yields |t [symbol] such that ƒ(t)=1 with certainty.

Note that the bound

$$⌊ \frac{π}{4 θ} ⌋ + 2$$

follows from the extra [symbol] applied at the beginning of the Amplitude Amplification (as we are counting the applications of [symbol] and [symbol] ^{t} and not iterations).

### III. Structure of the Wₘ Circuit

Definition 9. Let k̅=(k₁, . . . , kₘ) be a sequence of positive integers and let n:=Σⱼ₌₁^{m} kⱼ. Given a quantum oracle O, for j ∈{(0, . . . , m) we define the circuit Wⱼ recursively as follows:

W₀:Idₙ

Wⱼ:=Wⱼ₋₁·(Idₖ_{₁} _{+ . . . +k}_{_{j−1}}⊗Gₖ_{ⱼ}⊗Idₖ_{ⱼ₌₁}_{+ . . . +k}_{ₘ})·Wⱼ₋₁^{†}·O·Wⱼ₋₁,j∈{1,2, . . . ,m}.

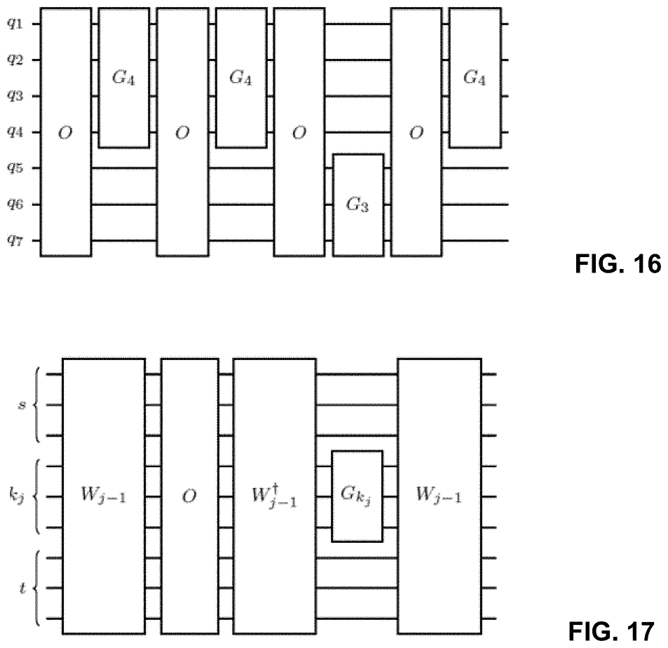

For an example of what the circuits Wₘ look like, See FIGS. 16 and 17. In particular, FIG. 16 presents the W₂ circuit where

k̅=(4,3)

FIG. 17 presents a graphical representation of the Wⱼ circuit. Note that the oracle in Wⱼ₋₁ manipulates all of the qubits, however no other gate does so. In this picture a=k₁+ . . . +kⱼ₋₁ and t=kⱼ₊₁+ . . . +kₘ.

### A. Obtaining the Recurrence for Amplitude in the Target

In this subsection we aim to derive a recurrence formula that will allow us to compute the amplitude our circuit Wₘ concentrates in the unique marked state. We assume we are given a phase oracle O operating on n qubits, that marks a single state denoted target. We have also fixed a vector of positive integers k̅=(k₁, . . . kₘ), such that k₁+ . . . +kₘ=n. For the duration of this section, we introduce the following notational conveniences. We split the marked state |target [symbol] according to k̅ as

$$\vert target 〉 = \vert {target}_{1} 〉 \vert {target}_{2} 〉 … \vert {target}_{m} 〉$$

where target₁ consists of bits of target numbered 1 to k₁, target₂ of the bits numbered k₁+1 to k₁+k₂ etc. Moreover, for given i, j we define the following product

$$\vert target \text{?} 〉 = \vert {target}_{1} 〉 \vert target \text{?} 〉 … \vert target \text{?} 〉 .$$

$$\text{?} \text{indicates text missing or illegible when filed}$$

If the interval {i,j} happens to be empty, we understand |targetᵢ^{j}) to be the scalar 1. To shorten the derivations about to follow, we will also use these shorthands

$$\vert {\overline{target}}_{j} 〉 = \frac{1}{{2}^{{k}_{1} / 2}} {\sum }_{{b ∈ ( 0 , 1 ) ⋆ j}_{b \neq {target}_{j}}} \vert b 〉 ,$$

$$\vert {u}_{1}^{j} 〉 = \vert {u}_{s} 〉$$

where r=k₁+ . . . +kⱼ with the additional convention that |uᵢ⁰)=1. Observe that we have the equations |uₖ_{ⱼ})=|t̅a̅r̅g̅e̅t̅ⱼ)+2^{-k}^{ⱼ}^{/2}|targetⱼ) and (targetⱼ|t̅a̅r̅g̅e̅t̅ⱼ)=0.

We begin by introducing two simple lemmas.

Lemma 10. Fix any m ∈ [symbol] ₊, and any k̅=(k₁, . . . , kₘ) ∈ [symbol] ₊^{m}, and let n=Σⱼ₌₁^{m}kⱼ. Assume that we are given a phase oracle O that operates on n qubits and marks a single vector of the standard computational basis denoted target. Then for any j ∈ {0, . . . ,m−1}, and any vector |ϕ)∈ ( [symbol] ²) [symbol] (where t=kⱼ₊₁+ . . . +kₘ) such that [symbol] ϕ|targetⱼ₊₁^{m})=0 we have

$${W}_{j} ( \vert {u}_{1}^{j} 〉 \vert ϕ 〉 ) = \vert {u}_{1}^{j} 〉 \vert ϕ 〉 .$$

Proof. Observe, that as [symbol] ϕ|targetⱼ₊₁^{m})=0 the vector |u [symbol] )|ϕ) is an eigenvector of the operator O with eigenvalue 1. Thus the lemma's assertion will be proved, if we show that it is also an eigenvector (with eigenvalue 1) of each diffusion operator that appears in Wⱼ, that is ((Idₐ⊗G_{d}⊗Id_{n-b-a})|u₁^{j})|ϕ)=|u₁^{j})|ϕ) whenever a+b≤k₁+k₂+ . . . +kⱼ, which we quickly verify by the direct calculation below.

$$( {ID}_{a} ⊗ {G}_{b} ⊗ {ID}_{n - b - a} ) ( \vert {u}_{1}^{j} 〉 \vert ϕ 〉 ) = ( {ID}_{a} ⊗ {G}_{b} ⊗ {ID}_{n - b - a} ) ( \vert {u}_{a} 〉 \vert {u}_{b} 〉 \vert {u}_{k} \text{?} 〉 \vert ϕ 〉 ) = ( {Id}_{a} \vert {u}_{a} 〉 ) ( {G}_{b} \vert u \text{?} 〉 ) ( {Id}_{n - b - a} \vert u \text{?} 〉 \vert ϕ 〉 ) = \vert {u}_{a} 〉 \vert {u}_{b} 〉 \vert u \text{?} 〉 \vert ϕ = \vert {u}_{1}^{j} 〉 \vert ϕ 〉 .$$

$$\text{?} \text{indicates text missing or illegible when filed}$$

Lemma 11. Fix any m ∈ [symbol] ₊, and any k̅=(k₁, . . . , kₘ) ∈ [symbol] ₊^{m}, and let n=Σⱼ₌₁^{m}kⱼ. Assume that we are given a phase oracle O that operates on n qubits and marks a single vector of the standard computational basis denoted target. Then for any j ∈ {1, . . . , m} we have

$${W}_{j - 1} ( {Id}_{s - {k}_{j}} ⊗ {G}_{{k}_{j}} ⊗ {Id}_{n - s} ) {W}_{j - 1}^{†} \vert target 〉 = ( \frac{2}{{2}^{{k}_{j}}} - 1 ) \vert target 〉 + \vert θ 〉$$

where a=k₁+ . . . +kⱼ, and |∂ [symbol] is some state orthogonal |target [symbol] .
Proof. Observe that each diffusion operator in Wⱼ₋₁ (and thus also in Wⱼ₋₁^{†}) operates on the qubits numbered {1, . . . , k₁+ . . . +kⱼ₋₁}, thus there exists a vector |η [symbol] ∈ ( [symbol] ²)^{⊗(k}^{₁}^{+ . . . +k}^{_{j−1}}⁾ such that

$${W}_{j - 1} \text{?} \vert target 〉 = \vert η 〉 \vert {target}_{j}^{m} 〉 .$$

$$\text{?} \text{indicates text missing or illegible when filed}$$

Equipped with this observation, we proceed to directly compute the desired result

$${W}_{j - 1} ( {Id}_{s - {k}_{j}} ⊗ {G}_{{k}_{j}} ⊗ {Id}_{n - s} ) {W}_{j - 1}^{†} \vert target 〉 = {W}_{j - 1} ( {Id}_{s - {k}_{j}} ⊗ {G}_{{k}_{j}} ⊗ {Id}_{n - s} ) \vert η 〉 \vert {target}_{j}^{m} 〉 = {W}_{j - 1} ( {Id}_{s - {k}_{j}} ) ⊗ {G}_{{k}_{j}} ⊗ {Id}_{n - s} ) \vert η 〉 \vert {target}_{j} 〉 \vert {target}_{j + 1}^{m} = {W}_{j - 1} ( \vert η 〉 ( {G}_{{k}_{j}} \vert {target}_{j} 〉 ) \vert {target}_{j + 1}^{m} 〉 ) = {W}_{j - 1} ( \vert η 〉 ( \frac{2}{{2}^{{k}_{j} / 2}} \vert {u}_{{k}_{j}} 〉 - \vert {target}_{j} 〉 ) \vert {target}_{j + 1}^{m} 〉 ) = {W}_{j - 1} ( \frac{2}{{2}^{{k}_{j}}} - 1 ) \vert η 〉 \vert {target}_{j}^{m} 〉 + {W}_{j - 1} \frac{2}{{2}^{{k}_{j} / 2}} \vert η 〉 \vert {\overline{target}}_{j} 〉 \vert {target}_{j + 1}^{m} 〉 = ( \frac{2}{{2}^{{k}_{j}}} - 1 ) \vert target 〉 + \vert θ 〉$$

and observe that |∂ [symbol] is orthogonal to |target [symbol] , as their respective preimages under Wⱼ₋₁ were orthogonal.
Lemma 12. Fix any m ⊗ [symbol] ₊, and any k̅=(k₁, . . . , kₘ) ∈ [symbol] ₊^{m}, and let n=Σⱼ₌₁^{m}kⱼ. Assume that we are given a phase oracle O that operates on n qubits and marks a single vector of the standard computational basis denoted target. Define the numbers

$${α}_{j} = 〈 target \vert ( {W}_{j} \vert {u}_{1}^{j} 〉 \vert {target}_{j + 1}^{m} 〉 )$$

for j ∈ {0, 1, . . . m}. Then αⱼ satisfy the recurrence

$${α}_{j} = \{ \begin{matrix}1 , & if j = 0 \\ {2}^{- {k}_{j} / 2} ( 3 - 4 \cdot {2}^{- {k}_{j}} ) {α}_{j - 1} , & if j > 0\end{matrix} .$$

Proof. Clearly α₀=1 giving the base case. Now, let us assume that j>0, and we will proceed to compute aⱼ, by expanding the circuit Wⱼ according to Definition [symbol] . To maintain legibility we will split this computation into several steps. Let us define the intermediate states |ω [symbol] , . . . , |ω [symbol] by the following equations

$$\vert {w}_{1} 〉 = {W}_{j - 1} ( \vert {u}_{1}^{j} 〉 \vert {target}_{j + 1}^{m} 〉 )$$

$$\vert {w}_{2} 〉 = O \vert {w}_{1} 〉$$

$$\vert {w}_{3} 〉 = {W}_{j - 1} \text{?} \vert {w}_{2} 〉$$

$$\vert {w}_{4} 〉 = ( Id \text{?} ⊗ {G}_{{k}_{j}} ⊗ Id \text{?} ) \vert {w}_{3} 〉$$

$$\vert {w}_{5} 〉 = {W}_{j - 1} \vert w \text{?} 〉$$

$$\text{?} \text{indicates text missing or illegible when filed}$$

where [symbol] =k₁+ . . . +kⱼ.

$$\begin{matrix}\vert {w}_{1} 〉 = {W}_{j - 1} ( \vert {u}_{1}^{j} 〉 \vert {target}_{j + 1}^{m} 〉 ) \\ = {W}_{j - 1} ( \frac{1}{{2}^{{k}_{j} / 2}} \vert {u}_{1}^{j - 1} 〉 \vert {target}_{j}^{m} 〉 + \vert {u}_{1}^{j - 1} 〉 \vert {\overline{target}}_{j} 〉 \vert {target}_{j + 1}^{m} 〉 ) \\ = \frac{1}{{2}^{{k}_{j} / 2}} {W}_{j - 1} \vert {u}_{1}^{j - 1} 〉 \vert {target}_{j}^{m} 〉 + \vert {u}_{1}^{j - 1} 〉 \vert {\overline{target}}_{j} 〉 \vert {target}_{j + 1}^{m} 〉\end{matrix} \qquad ( 1 )$$

Where in eq. [symbol] we relied on Lemma [symbol] Plugging this equation into the definition of |ω₂ [symbol] we obtain

$$\begin{matrix}\vert {w}_{2} 〉 = 𝒪 ( \frac{1}{{2}^{{k}_{j} / 2}} {W}_{j - 1} \vert {u}_{1}^{j - 1} 〉 \vert {target}_{j}^{m} 〉 + \vert {u}_{1}^{j - 1} 〉 \vert {\overline{target}}_{j} 〉 \vert {target}_{j + 1}^{m} 〉 ) \\ = \frac{1}{{2}^{{k}_{j} / 2}} {W}_{j - 1} \vert {u}_{1}^{j - 1} 〉 \vert {target}_{j}^{m} 〉 - 2 {α}_{j - 1} \vert target 〉 ) + \vert {u}_{1}^{j - 1} 〉 \vert {\overline{target}}_{j} 〉 \vert {target}_{j + 1}^{m} 〉\end{matrix} \qquad ( 2 )$$

$$\begin{matrix}\vert {w}_{3} 〉 = {W}_{j - 1}^{†} ( \frac{1}{{2}^{{k}_{j} / 2}} {W}_{j - 1} \vert {u}_{1}^{j - 1} 〉 \vert {target}_{j}^{m} 〉 - \frac{2}{{2}^{{k}_{j} / 2}} {α}_{j - 1} \vert target 〉 + \\ \vert {u}_{1}^{j - 1} 〉 \vert {\overline{target}}_{j} 〉 \vert {target}_{j + 1}^{m} 〉 ) \\ = \frac{1}{{2}^{{k}_{j} / 2}} \vert {u}_{1}^{j - 1} 〉 \vert {target}_{j}^{m} 〉 - \frac{2}{{2}^{{k}_{j} / 2}} {α}_{j - 1} {W}_{j - 1}^{†} \vert target 〉 + \\ \vert {u}_{1}^{j - 1} 〉 \vert {\overline{target}}_{j} 〉 \vert {target}_{j + 1}^{m} 〉\end{matrix} \qquad ( 3 )$$

$$= \vert {u}_{1}^{j} 〉 \vert {target}_{j + 1}^{m} 〉 - \frac{2}{{2}^{{k}_{j} / 2}} {α}_{j - 1} {W}_{j - 1}^{†} \vert target 〉 \qquad ( 4 )$$

$$\begin{matrix}\vert {w}_{4} 〉 = {Id}_{s - {k}_{j}} ⊗ {G}_{{k}_{j}} ⊗ {Id}_{n - s} ( \vert {u}_{1}^{j} 〉 \vert {target}_{j + 1}^{m} 〉 - \frac{2}{{2}^{{k}_{j} / 2}} {α}_{j - 1} {W}_{j - 1}^{†} \vert target 〉 ) \\ = \vert {u}_{1}^{j} 〉 \vert {target}_{j + 1}^{m} 〉 - \frac{2}{{2}^{{k}_{j} / 2}} {α}_{j - 1} ( {Id}_{s - {k}_{j}} ⊗ {G}_{{k}_{j}} ⊗ {Id}_{n - s} ) {W}_{j - 1}^{†} \vert target 〉\end{matrix} \qquad ( 5 )$$

$$\begin{matrix}\vert {w}_{5} 〉 = {W}_{j - 1} ( \vert {u}_{1}^{j} 〉 \vert {target}_{j + 1}^{m} 〉 - \frac{2}{{2}^{{k}_{j} / 2}} {α}_{j - 1} ( {Id}_{s - {k}_{j}} ⊗ {G}_{{k}_{j}} ⊗ {Id}_{n - s} ) {W}_{j - 1}^{†} \vert target 〉 ) \\ = \frac{1}{{2}^{{k}_{j} / 2}} {W}_{j - 1} ( \vert {u}_{1}^{j} 〉 \vert {target}_{j + 1}^{m} 〉 + \vert {u}_{1}^{j - 1} 〉 \vert {\overline{target}}_{j} 〉 \vert {target}_{j + 1}^{m} 〉 - \\ \frac{2}{{2}^{{k}_{j} / 2}} {α}_{j - 1} {W}_{j - 1} ( {Id}_{s - {k}_{j}} ⊗ {G}_{{k}_{j}} ⊗ {Id}_{n - s} ) {W}_{j - 1}^{†} \vert target 〉\end{matrix}$$

$$= \frac{1}{{2}^{{k}_{j} / 2}} {W}_{j - 1} ( \vert {u}_{1}^{j} 〉 \vert {target}_{j}^{m} 〉 + \vert {u}_{1}^{j - 1} 〉 \vert {\overline{target}}_{j} 〉 \vert {target}_{j + 1}^{m} 〉 - \frac{2}{{2}^{{k}_{j} / 2}} {α}_{j - 1} ( ( \frac{2}{{2}^{{k}_{j}}} - 1 ) \vert target 〉 + \vert θ 〉 ) \qquad ( 6 )$$

Note that in eq. ( [symbol] ) we used the definition of αⱼ₋₁, in eq. ( [symbol] ) we applied Lemma [symbol] eqs. ( [symbol] ) and ( [symbol] ) follows from the definition of |t̅a̅r̅g̅e̅t̅ⱼ [symbol] _{, while eq. (} [symbol] _{) we applied Lemma} [symbol] _{. Keeping in mind that |δ} [symbol] _{is orthogonal to |target} [symbol] _{and equipped with eq. (} [symbol] _{163 ) we may finally compute α}ⱼ as

$${α}_{j} = ( target \vert {w}_{5} 〉 = \frac{1}{{2}^{{k}_{j} / 2}} 〈 target \vert ( {W}_{j - 1} \vert {u}_{1}^{j - 1} 〉 \vert {target}_{j + 1}^{m} 〉 + 2 {α}_{j - 1} ( 1 - \frac{2}{{2}^{{k}_{j}}} \vert target 〉 ) = \frac{1}{{2}^{{k}_{j} / 2}} ( {α}_{j - 1} + 2 {α}_{j - 1} ( 1 - \frac{2}{{2}^{{k}_{j}}} ) ) = \frac{1}{{2}^{{k}_{j} / 2}} ( 3 - 4 \cdot {2}^{- {k}_{j}} ) {α}_{j - 1} . \qquad □$$

### B.Proof of Theorem

Proof of Theorem [symbol] It clearly suffices to prove the theorem under assumption that ε is small enough, let us assume that is indeed the case.

Let k̅=(k₁, . . . , kₘ) be some sequence of positive integers to be determined later, such that Σⱼ₌₁^{m}kⱼ=n. We will use the circuit Wₘ with these diffuser sizes, and utilise Theorem [symbol] on top of this circuit. To estimate the number of iterations made by Amplitude Amplification, we need a precise formula for amplitude in the marked state that the circuit WₘH^{⊗n} (the Walsh-Hadamard transform is only necessary because we assumed our circuit to be fed the state |uₙ [symbol] , while Amplitude Amplification assumes that the state |00 . . . 0) is the one we work with) yields—denoted αₘ. To this end we use the recur we have obtained in Lemma [symbol] to which we can provide a solution as a product

[symbol]

$$\begin{matrix}{α}_{m} = {{\prod }_{j = 1}}^{m} ( {2}^{- {k}_{j} / 2} ( 3 - 4 \cdot {2}^{- {k}_{j}} ) ) \\ = {2}^{- n / 2} {{\prod }_{j = 1}}^{m} ( 3 - 4 \cdot {2}^{- {k}_{j}} ) \\ = {2}^{- n / 2} \cdot {3}^{m} {{\prod }_{j = 1}}^{m} ( 1 - \frac{4}{3} \cdot {2}^{- {k}_{j}} )\end{matrix} . \qquad ( 7 )$$

Let us now consider the case of particular choice of k̅, namely kⱼ=(x+1)ⱼ, where e ∈ [symbol] ₊ is some fixed constant. We will for now assume, for the sake of simplicity, that the number of qubits n is precisely equal to (x+1)+2(x+1)+ . . . +m(x+1)=(x+1) m(m+1)/2. We will later argue that this assumption is not necessary. Observe that in particular we have

$$m ∈ Θ ( \sqrt{n / x} ) . \qquad ( 8 )$$

Thus we can lower bound the product in αₘ as follows: It is interesting to note, that setting each kⱼ=2 yields αₘ=1 in which case Amplitude Amplification is not necessary, thus giving a simple algorithm solving the unstructured search problem with each diffuser size bounded by a constant. However, the number of oracle queries it makes is [symbol] (3^{n/2}).

$$\text{?}$$

$$\text{?} \text{indicates text missing or illegible when filed}$$

We recall the beautiful identity due to Euler [symbol] , which relates the infinite product on right hand side with pentagonal numbers

$$\text{?}$$

$$\text{?} \text{indicates text missing or illegible when filed}$$

which we use to lower bound the product for z ∈ [0, 1) as

$$\text{?}$$

$$\text{?} \text{indicates text missing or illegible when filed}$$

by grouping latter terms in the series in consecutive pairs and observing that each such pair has a positive sum. This gives us the inequality

$${α}_{m} \geq {2}^{- n / 2} \cdot {3}^{m} \cdot ( 1 - {2}^{- x} - {2}^{- 2 x} ) . \qquad ( 9 )$$

Using Theorem [symbol] we need at most

$$\text{?}$$

$$\text{?} \text{indicates text missing or illegible when filed}$$

applications of our circuit Wₘ and its conjugate, where θₘ=arcsin αₘ. Using the standard inequality for z∈(0, 1]

$$sin 𝓏 \leq 𝓏$$

which we can restate as

$$\text{?}$$

$$\text{?} \text{indicates text missing or illegible when filed}$$

Inequalities [symbol] and [symbol] together imply that the number of applications of Wₘ and Wₘ^{†} in Amplitude Amplification is bounded by

$$\text{?}$$

$$\text{?} \text{indicates text missing or illegible when filed}$$

Observe that each Wₘ (and thus also Wₘ^{†}) uses (3^{m}−1)/2 oracle calls. Thus the total number of oracle calls is bounded by

$$\text{?}$$

$$\text{?} \text{indicates text missing or illegible when filed}$$

thus, we are only a factor of

$$\text{?}$$

$$\text{?} \text{indicates text missing or illegible when filed}$$

away from optimal number of oracle calls, as by eq. ( [symbol] ) the additive term is negligible.

Let us count the number of non-oracle gates used by our algorithm. Note that the overhead of operations used by Amplitude Amplification other than applications of Wₘ is negligible compared to the cost of the Wₘ circuit. Each Wₘ can be implemented using

$$\text{?}$$

$$\text{?} \text{indicates text missing or illegible when filed}$$

non-oracle gates, giving us at most

$$\text{?}$$

$$\text{?} \text{indicates text missing or illegible when filed}$$

non-oracle gates used by the entire algorithm. Now setting x ∈ θ(log(ε⁻¹)) concludes the proof in this special case.

Now we briefly explain how to deal with arbitrary number of qubits. We wish to get a suitable sequence k̅ for a specific positive integers x and n, We do it as follows: let m=max{k: Σ_{j≤k} (x+1)j≤n}, and define for j ∈ {1, . . . m}}

$$\text{?}$$

$$\text{?} \text{indicates text missing or illegible when filed}$$

By the choice of m, we easily get that kₘ ∈ [(x+1)m, 3(x+1)m). Observe that the number of gates necessary to implement Wₘ goes up by a factor of at most 3, thus that part of the calculation does not change. Next, observe that in eq. ( [symbol] ), the final expression is monotonely increasing in kⱼ, thus our lower bound in inequality [symbol] still holds. Thus, further analysis also does not change, concluding the proof. [symbol]
Remark 13. The above analysis could be generalised to the setting of underlying space being decomposable into a tensor product as

H₁⊗H₂⊗ . . . ⊗Hₘ

where of course the time complexity of the algorithm will depend on the relative dimensions of Hⱼ, However, this would not improve the proof's clarity, and does not really provide a significant wider scope of applications, so we refrain from including it.

### IV. Optimality

In this section we show the following lower bound for the number of oracle queries.

Theorem 14. Fix p ∈ (0,1), n ∈ [symbol] and N=2ⁿ. Let T=T(N,p) be the number of oracle queries in the optimal (i.e., minimizing the number of oracle queries) search algorithm that is needed to find the marked element with probability at least p. There exists a constant C>0, which possibly depends on p but does not depend on N, such that for any η>0 and any algorithm [symbol] A the following holds. If [symbol] uses at most ηT additional basic gates and finds the marked element with probability at least p then [symbol] needs to query oracle at least T+└2^{-Cη}T ┘ times.

As a byproduct we reprove the Zalka's estimation from [symbol] (Corollary [symbol] ) and at the end of the section we shortly explain how the above theorem implies Corollary [symbol] .

Let m≥n be the number of qubits which we use. Assume that we have at our disposal a phase oracle O^{y} operating on n qubits with one marked element y. Any quantum algorithm that solves unstructured search problem has the following form: we start with some initial quantum state |s [symbol] and apply the alternating sequence of oracle queries O^{y} and unitary operators U₁, . . . , U_{R} (each of which acts on m qubits). Thus as a result we get a state

|t [symbol] =U_{R}O^{y}U_{R-1}O^{y} . . . U₁O^{y}|

[symbol]

It is convenient to investigate the algorithm's behavior for all possible y ∈ {0, 1}ⁿ simultaneously. For this purpose we consider the following sphere and its subset. Let

S={z∈(( [symbol] ²)^{⊗m})^{N}:|z|=\sqrt{N}}

and

Ŝ=((z₁, . . . ,z_{N})∈S:z₁= . . . =z_{N})

Let yⱼ for j ∈ {1, . . . , N} be a sequence of all elements of (0, 1)ⁿ. We use the following two actions of unitary group on the sphere S. For U ∈ U(2^{m}) and z in S we put:

Uz=(Uz₁,Uz₂, . . . ,Uz_{N})

and

O_{U}z=(UO^{y}^{₁}z₁,UO^{y}^{₂}z₂, . . . ,UO^{y}^{_{N}}z_{N}).

By straightforward calculations we get the following observation.
Observation 15. For z in Ŝ we have

|O_{U}z−Uz|=2,

We consider the following sequences of points on the sphere S.

S= [symbol] |S [symbol] , . . . ,|s)) and s_{S}=O_{U}_{_{R}} . . . O_{U} [symbol] +1U_{S} . . . U₁s̅.

Let us recall the inequality proved in [symbol] (see also [symbol] ) which is crucial for our considerations
Lemma 16. If the algorithm finds marked element with probability at least p, then

|s_{R}−s₀|²≥h(p), (11

where h is a function given by the formula

h(p)=2N−2\sqrt{N}\sqrt{p}−2\sqrt{N}\sqrt{N−1}\sqrt{1−p}.

The advantage of working on the sphere is that the distance between points on the sphere S is connected with the angle between them. For a, b ∈ [symbol] let φ_{a,b} be the angle between them i.e.

$$\text{?}$$

$$\text{?} \text{indicates text missing or illegible when filed}$$

Such angle is proportional to the length of the shortest arc on S connecting a and b, so in particular it satisfies triangle inequality:

φ_{a,b}+φ_{b,c}+φ_{a,c}

### Put

α=2 arcsin(1/\sqrt{N}). (13)

Now let us consider distances between elements of sequence sₜ.
Observation 17. For i ∈ {0, . . . , R−1) we have

|sₜ−sₜ₊₁|=2 and φₓ_{ᵢ} [symbol] +1=α

Proof. By Observation [symbol] we have

|sₜ−sₜ₊₁|=|O_{U}z−Uz|=2

where U=Uₛ₊₁ and z=Uₛ . . . U₁s₀. The second part follows trivially from eq. ( [symbol] ) and the choice of α.□
Observation 18. For any i,c ∈ [symbol] such that i+c≤R, the following inequality holds:

φ

[symbol]

Proof. The inequality holds by the Observation [symbol] and the triangle inequality for angles.

[symbol]

If we look at Grover's algorithm we can notice the following facts.

Observation 19. In case of Grover's algorithm we have equality in the inequality given by Observation [symbol] for

$$\text{?}$$

$$\text{?} \text{indicates text missing or illegible when filed}$$

Observation 20. In case of Grover's algorithm all points s₀, . . . , s_{R} lie on a great circle of the sphere S.
Lemma 21. For a given

$$\text{?}$$

$$\text{?} \text{indicates text missing or illegible when filed}$$

the expression |s_{R}−s₀| is maximised by Grover's algorithm.
Proof. Since in the case of Grover's algorithm points s₀, . . . , s_{R} lie on the great circle we get φₓ [symbol] ,ₓ_{_{R}}=Rα and thus the distance between s₀ and s_{R} is maximised. □

Let us recall the result of Zalka. By above Lemma, Observation [symbol] and Lemma [symbol] we get the following.

Corollary 22 (Zalka's lower bound for search algorithm). Let

$$λ R \leq ( \frac{2 π}{\text{?}} - 1 ) / 2.$$

$$\text{?} \text{indicates text missing or illegible when filed}$$

The Grover's algorithm that makes R oracle queries gives maximal probability of measuring marked element among all quantum circuits that solve unstructured quantum search problem using at most R queries.

Note that for large N the number

$$\text{?}$$

$$\text{?} \text{indicates text missing or illegible when filed}$$

is close to

$$\frac{π}{\text{?}} \sqrt{N} .$$

$$\text{?} \text{indicates text missing or illegible when filed}$$

Now let us see what happens after two steps of the algorithm. Put d_{K}=16(K−1)/K for K≥1.

Observation 23. If z ∈ S, then 9|O_{Id}O_{U}z|²≤d_{N}. In particular for i ∈ {0, . . . , R−2) we have

|sₜ−sₜ₊₂|²≤d_{N}.

Proof. It is the direct consequence of Observation [symbol] for c=2.□

The key observation for our lower bound is better estimation for unitary operators that act on bounded number of qubits. From this point of view we consider that each oracle query can be performed on arbitrary qubits in arbitrary order (or we can think that we just add SWAP gates). To stress this we use here the symbols O and O′ for oracle operators.

Lemma 24. Let z=(|z), . . . , |z [symbol] ) ∈Ŝ. If U acts at most on k qubis, then |O′_{Id}O_{U}z−Uz|²≤d_{K}_{²} where K=2^{k},
Proof. Let A_{U} be the set of k qubits on which U acts. Oracle O acts on qubits Q₁, . . . , Qₙ and O′ on Q′₁, . . . , Q′ₙ (here of course the order of qubits is important). Let J_{O} be a set of all such indices i that Qₛ ∈ A_{U}, and J_{O′} be a set of all incides j that Q′ⱼ ∈ A_{U}. Without loss of generality we can assume that J=J_{O}∪J_{O′}={n+1−a, . . . , n}. Note that a≤2k, since |J_{O}|,|J′_{O}|≤|A_{U}|≤k. Put

B=A_{B}∪{Qₙ₊₁₋ₐ, . . . ,Qₙ}∪{Q′ₙ₊₁₋ₐ, . . . ,Q′ₙ}.

Let B′ be a set of all other qubits. Oy the assumption above, it is a prefix of the set of all qubits.

Let us fix for a moment y=(y₁, . . . , yₙ) ∈ {0,1}ⁿ. Let q=(y₁, . . . , yₙ₋ₐ) ∈ {0, 1}^{n-a} and r=yₙ₋ₐ₊₁, . . . , yₙ) ∈ {0, 1}^{a}. We will also write qr in place of y. With these notions introduced, we can write |z [symbol] as:

$$\vert 𝓏 〉 = {\sum }_{\vert x 〉 ∈ {B}^{′}} {α}_{x} \vert x 〉 \vert {S}_{x} 〉 ,$$

where B′ is a computational basis in the space related to qubits from B′, α_{z} are complex number and |S_{z} [symbol] are states in the space related to qubits in B. It is clear that

$${\sum }_{\vert x 〉 ∈ {B}^{′}} {\vert {α}_{x} \vert}^{2} = 1.$$

We group elements of B′ into four disjoint sets. Let B₁^{q} be the set of all |r [symbol] that agree with yⱼ on qubits Qⱼ and Q′ⱼ for all j≤n−a. Let B₂^{q} (respectively B₃^{q}) be the set of all |x [symbol] that agree with pⱼ on qubits Qⱼ (respectively Q′ⱼ) for all j≤n−a but differs on at least one qubit Q′ⱼ (respectively Qⱼ) for some j≤n−a. And finally we put B₄^{q}=B′\(B₁^{q}∪B₂^{q}∪B₃^{q}). Now we have

$$\vert 𝓏 〉 = {\sum }_{\text{?} = 1}^{4} \vert 𝓏 \text{?} 〉 ,$$

$$\vert 𝓏 \text{?} 〉 = {\sum }_{\vert x 〉 ∈ B \text{?}} {α}_{x} \vert x 〉 \vert {S}_{x} 〉 .$$

$$\text{?} \text{indicates text missing or illegible when filed}$$

We have

$$U \vert 𝓏 \text{?} 〉 = {\sum }_{\vert x 〉 ∈ B \text{?}} {α}_{x} \vert x 〉 U \vert {S}_{x} 〉 ,$$

$$O \text{?} UO \text{?} \vert {𝓏}_{1}^{q} 〉 = {\sum }_{\vert x 〉 ∈ B \text{?}} {α}_{x} \vert x 〉 O \text{?} UO \text{?} \vert {S}_{x} 〉 ,$$

$$O \text{?} UO \text{?} \vert {𝓏}_{2}^{q} 〉 = {\sum }_{\vert x 〉 ∈ B \text{?}} {α}_{x} \vert x 〉 O \text{?} UO \text{?} \vert {S}_{x} 〉 ,$$

$$O \text{?} UO \text{?} \vert {𝓏}_{3}^{q} 〉 = {\sum }_{\vert x 〉 ∈ B \text{?}} {α}_{x} \vert x 〉 O \text{?} UO \text{?} \vert {S}_{x} 〉 ,$$

$$O \text{?} UO \text{?} \vert 𝓏 \text{?} 〉 = U \vert 𝓏 \text{?} 〉 ,$$

$$\text{?} \text{indicates text missing or illegible when filed}$$

where O^{r} (and respectively Qⁿ) are oracles on a qubits that mark element of the computational basis if for k>n−a on Qₖ (respectively on Q′ₖ) this element is yₖ. We get

$${{{{\vert O \text{?} UO \text{?} \vert 𝓏 〉 - U \vert 𝓏 〉}^{2} = {\sum }_{\vert x 〉 ∈ B \text{?}} {\vert {α}_{x} \vert}^{2} \vert ( U - O \text{?} UO \text{?} ) \vert {S}_{x} 〉 \vert}^{2} + {\sum }_{\vert x 〉 ∈ B \text{?}} {\vert {α}_{x} \vert}^{2} \vert ( 1 - O \text{?} ) \vert {S}_{x} 〉 \vert}^{2} + {\sum }_{\vert x 〉 ∈ B \text{?}} {\vert {α}_{x} \vert}^{2} \vert ( 1 - O \text{?} ) U \vert {S}_{x} 〉 \vert}^{2} .$$

$$\text{?} \text{indicates text missing or illegible when filed}$$

Now we are ready to sum up above expression with respect to r. For a fixed q, by applying Observation [symbol] , we get

$${{{\sum }_{r} \vert O \text{?} UO \text{?} \vert 𝓏 〉 - U \vert 𝓏 〉 \vert}^{2} = {\sum }_{\vert x 〉 ∈ B \text{?}} {\vert {α}_{x} \vert}^{2} {\sum }_{r} \vert ( O \text{?} UO \text{?} - U ) \vert {S}_{x} 〉 \vert}^{2} + 4 {\sum }_{\vert x 〉 ∈ B \text{?}} {\vert {α}_{x} \vert}^{2} \leq {d}_{{2}^{a}} {\sum }_{\vert x 〉 ∈ B \text{?}} {\vert {α}_{x} \vert}^{2} + 4 {\sum }_{\vert x 〉 ∈ B \text{?}} {\vert {α}_{x} \vert}^{2} \leq {d}_{{K}^{3}} / 2 ( {\sum }_{\vert x 〉 ∈ B \text{?}} {\vert {α}_{x} \vert}^{2} + {\sum }_{\vert x 〉 ∈ B \text{?}} {\vert {α}_{x} \vert}^{2} ) .$$

$$\text{?} \text{indicates text missing or illegible when filed}$$

The inequality in fourth line holds by applying Observation [symbol] in case of N=2^{a}.

The next step is sum the bound above with respect to q. Notice that

$${⋃}_{q} {B}_{1}^{q} ⋃ {B}_{2}^{q} = {⋃}_{q} {B}_{1}^{q} ⋃ {B}_{q}^{q} = {B}^{′} ,$$

since if for a fixed q one oracle marks some state |z [symbol] ∈ [symbol] ′, then the other oracle either agrees with it (putting |z [symbol] in [symbol] ₁^{q}) or not (putting it in [symbol] ₂^{q}, or [symbol] ₃^{q}, respectively). Because of that and the fact that for different qs oracle marks disjoint |z [symbol] s, the ∪ symbol is to be understood as disjoint set union. Therefore we have

$$\vert 𝓏 〉 = {\sum }_{q} {\sum }_{\vert x 〉 ∈ B \text{?}} {α}_{x} \vert x 〉 \vert {S}_{x} 〉 = {\sum }_{q} {\sum }_{\vert x 〉 ∈ B \text{?}} {α}_{x} \vert x 〉 \vert {S}_{x} 〉$$

$$\text{?} \text{indicates text missing or illegible when filed}$$

and thus

$${\sum }_{q} {\sum }_{\vert x 〉 ∈ B \text{?}} {\vert {α}_{x} \vert}^{2} = {\sum }_{q} {\sum }_{\vert x 〉 ∈ B \text{?}} {\vert {α}_{x} \vert}^{2} = 1.$$

$$\text{?} \text{indicates text missing or illegible when filed}$$

Finally we can conclude

$${{{\vert {O}^{′} \text{?} {O}_{U} 𝓏 - U 𝓏 \vert}^{2} = {\sum }_{y} \vert O \text{?} UO \text{?} \vert 𝓏 〉 - U \vert 𝓏 〉 \vert}^{2} = {\sum }_{q} {\sum }_{p} \vert O \text{?} UO \text{?} \vert 𝓏 〉 - U \vert 𝓏 〉 \vert}^{2} \leq {d}_{{K}^{2}} .$$

$$\text{?} \text{indicates text missing or illegible when filed}$$

Proof of Theorem [symbol] . Let us choose k=8η. Note that if k>n/4 then for any C≥32 we get T2^{-Cη}≤(π\sqrt{N}/4+1) N<1 and we are done, so we can assume that k≤n/4.

By Observation [symbol] for all i ∈ {0, . . . , R−2} we have

φ [symbol] ≤2α=2 arcsin (\sqrt{d_{N}}/2\sqrt{N}),

and by Lemma [symbol] if operator Uₜ₊₁ acts on at most k qubits then

$$φ \text{?} \leq 2 arcsin ( \frac{\sqrt{{d}_{{K}^{2}}}}{2 \sqrt{N}} ) ,$$

$$\text{?} \text{indicates text missing or illegible when filed}$$

We will use either of these bounds depending on whether an operator acts on more than k qubits or not. Note that the second bound is always better than the first one, as we assumed that k≤n/4.

Since arcsin has the derivative greater or equal to one, for Uₜ₊₁ acting on at most k qubits we can bound

$$φ \text{?} \leq 2 arcsin ( \frac{\sqrt{{d}_{{K}^{2}}}}{2 \sqrt{N}} ) - 2 \frac{\sqrt{{d}_{N}} - \sqrt{{d}_{{K}^{2}}}}{2 \sqrt{N}} \leq 2 α - \frac{D}{{K}^{2} \sqrt{N}} ,$$

$$\text{?} \text{indicates text missing or illegible when filed}$$

where the constant D (as well as constants D′ and C below) does not depend on N and K. The inequality arcsin x≤2x for x=1/\sqrt{N} combined with eq. ( [symbol] ) yields

φ [symbol] ≤2α(1−D/δK²)

From the triangle inequality for angles we can now establish the following bound

$$φ \leq α + {\sum }_{\text{?}} φ \text{?}$$

$$where$$

$$\hat{α} = \{ \begin{matrix}α & if R is an odd number , \\ 0 & if R is an even number\end{matrix} .$$

$$\text{?} \text{indicates text missing or illegible when filed}$$

Note that, since each basic gate acts on at most two qubits, at least half of operators U₂ₜ₊₁ act on at most k qubits. Therefore we can bound half of the angles by 2α(1−D/δK²) and the rest by 2α, which gives us

$$φ \text{?} \leq R α = \frac{{D}^{′} R}{{K}^{2}} α \leq α R ( 1 - {2}^{- C η} ) .$$

$$\text{?} \text{indicates text missing or illegible when filed}$$

On the other hand by Lemma [symbol] and Observation [symbol] have

_{δ}_{_{R}}_{,δ}_{_{C}}>(T−1)α

and thus

R>(T−1)(1−2^{-Cη}≥T−1+2^{-Cη}T

and the Theorem follows, □
proof of Corollary [symbol] One can see that any algorithm needs more than

$$\frac{π}{4} \sqrt{N} - 1$$

steps to find the marked element with certainty (compare Corollary [symbol] ). Using Theorem [symbol] we get the results for δ=1/C and for large enough n. If necessary, we may decrease δ so that δlog (1/δ) \sqrt{N}<1 for smaller values of n. [symbol]
Remark 25. Note that we do not allow measurements before the end of the algorithm. It is not clear to the authors how measurements performed inside a circuit can reduce the expected number of oracle queries made. In particular, how Zalka's results about optimality of Grover's algorithm applies to this more general class of quantum algorithms is far from obvious. Example of measurements speeding up quantum procedures can be found in section 4 of [symbol] or in the last section of this paper.

### V. Partial Uncompute

### A. Motivation and Intuition

The motivation for this section comes from the fact that many natural implementations of phase oracle mimic parallel classical computation by the following pattern of operations.
1. We perform a long series of operations that do not alter the original n qubits (or alter them temporarily), but modify some number of ancilla qubits that were initially zero, usually by CCX gates.
2. We perform a Z gate operation to flip the phase on the interesting states.
3. We undo all the operations from step (1), not to hinder the amplitude interference in the subsequent mixing operators.
   Step (3) offers the benefit of being able to reuse the (now cleared) ancilla qubits, but it is not the main motivation of performing it.

If a mixing operators used only acts on a subset of qubits, may be not all gates from step (1) interfere with proper amplitude interference? It turns out that very often it suffices to undo only a fraction of gates. We will stablish the proper language to express that in section [symbol] .

It turns out that the state that allows safe application of the mixing operator is much closer (in the metric of number of gates) to the state from alter step (1) that to the base state with all ancilla qubits zeroed. Our approach will initially compute all the ancilla qubits, perform all the mixing “closed” to this state, and finally uncompute the ancillas.

Intuitively, we shall follow the following new scheme.
1. Compute all the ancilla qubits.
2. For all mixing operators, perform the following
   (a) Perform the phase flip.
   (b) Undo the ancilla computation that would interfere with the upcoming mixing operator.
      (c) Perform the mixing.
   (d) Redo the computation from step 2(b).
3. Uncompute all the ancilla qubits.
   The last step (2d) and step (3) could be even skipped, if the ancilla computation does not modify the original qubits. However we are not doing this optimization in the formal approach, as the benefits are minimal.

Naturally, this is a very imprecise description. Full details are presented in section

[symbol]

We are aware that many (if not all) of these operations are performed by modern quantum circuit optimizers and preprocessors. The aim is to give structure to the process and understand how many gates are guaranteed to be removed from the circuit.

### B. Definitions

Recall from section [symbol] that a phase oracle O of a function ƒ: {0, 1}ⁿ→{0, 1} is a unitary transformation given In O|x [symbol] =(−1)^{ƒ(x)}|x [symbol] for all vectors |x [symbol] in the computational basis.

Definition 26. We will say that a phase oracle O admits an uncomputable decomposition (Oᵤ,Oₚ) if O=Oᵤ^{f}∘Oₚ∘Oᵤ. We call Oᵤ and Oₚ the uncomputable part and the phase part, respectively.
Remark 27. Note that neither Oᵤ nor Oₚ need to be phase oracles themselves. Naturally, every phase oracle O on n qubits admits a trivial decomposition (Idₙ, O). However, in practice, many real-life examples give more interesting decompositions. The intuitive goal is to make the phase part as simple as possible. The more gates needed to implement O we manage to move to the uncomputable part, the more gates we can hope to cancel out. A common pattern in many settings is to use an ancilla to mark the sought state by a bitflip, apply Z gate on said ancilla, followed by uncomputing the ancilla. In such case, there is a natural uncomputable decomposition of O.
Definition 28. Let A₁, . . . , A [symbol] be a chronologically ordered sequence of unitary matrices corresponding to the gates in a quantum circuit operating on n qubits (ties being broken arbitrarily). We will define the fact that Aⱼ depends on qubit qᵢ, i ∈ {1, . . . , n}, by induction on j ∈ {1, . . . , [symbol] }

We say that Aⱼ depends on qₜ if Aⱼ acts on qₜ or if there exist i₀ ∈ {1, . . . , n} and j₀ ∈ {(1, . . . , j−1} such that the following hold.
Aⱼ_{₁} depends on qₜ.
Aⱼ_{₂} acts on qₜ_{₀}.
Aⱼ acts on qₜ_{₀}.

In this section, by [symbol] (X) we will denote the powerset of X, that is the set of all subsets of X.

Definition 29. Let O be a phase oracle on n qubits, [symbol] ∈ [symbol] ; {1, . . . , [symbol] }→ [symbol] ({q₁, . . . , qₙ}), and U:{1, . . . , [symbol] } [symbol] j [symbol] Uⱼ ∈ U(n). Assume that Uⱼ is an arbitrary unitary operator acting on the qubit set d(j), j ∈ 55 1, . . . , [symbol] }₂. We define a generic oracle circuit V( [symbol] , d, U, O) by the following formula (the product is to be understood as right-to-left operator composition):

$$V ( ℓ ; d , U , O ) := {{\prod }_{j = 1}}^{ℓ} ( {U}_{j} ∘ O ) .$$

Remark 30. Observe that Wₘ from Definition [symbol] is a generic oracle circuit.
Proof. For j ∈ {1, . . . , m} put [symbol] ⱼ:=(3^{j}−1)/2 and define dⱼ:{1, . . . , [symbol] ⱼ [symbol] [symbol] (}1, . . . , k₁+ . . . +kⱼ}) recursively as follows:

$${d}_{j} ( i ) := \{ \begin{matrix}{d}_{j - 1} ( i ) , & 1 \leq i \leq {ℓ}_{j - 1} , \\ \{ {k}_{1} + … + {k}_{j - 1} + 1 , … , {k}_{} + … + {k}_{j} \} , & i = {ℓ}_{j - 1} + 1 , \\ {d}_{j - 1} ( 2 {ℓ}_{j - 1} + 2 - 1 ) , & {ℓ}_{j - 1} + 2 \leq i \leq 2 {ℓ}_{j - 1} + 1 , \\ {d}_{j - 1} ( i - 2 {ℓ}_{j - 1} - 1 ) , & 2 {ℓ}_{j - 1} + 2 \leq i \leq {ℓ}_{j}\end{matrix} .$$

We then set Uⱼ to be the mixing operator G_{|d}_{ₘ}_{(j)|} applied onto the qubits in the set dₘ(j), j ∈ [symbol] ₘ. Observe that Wₘ=V( [symbol] ₘ, dₘ, U, O).

[symbol]

### C. Reducing the Number of Gates

Theorem 31. Let (Oᵤ, Oₚ) be an uncomputable decomposition of O and let Dᵤ, and Dₚ, be the total number of gates used in Oᵤ, and Oₚ, respectively. Let D̅ₛ denote the number of gates within Oᵤ that depend on any of the qubits in s, for all s ∈ [symbol] {1, . . . , n}).

For a given generic oracle circuit V( [symbol] , d, U, O) one can implement an equivalent circuit \tilde{V} that uses a total of 2Dᵤ+ [symbol] Dₚ+2 [symbol] ₌₁D̅_{d(ƒ)} gates for oracle queries. This results in no more than the following average number of gates per oracle query:

$${D}_{p} + 2 \frac{{D}_{u}}{ℓ} + 2 \frac{{\sum }_{j = 1}^{ℓ} {\overline{D}}_{d ( j )}}{ℓ} .$$

Proof. Let Oₛ (resp. Õₛ) be the in-order composition of all gates in Oᵤ that depend (resp. do not depend) on any of the qubits in s, for all s ∈ [symbol] ({1, . . . , n}).

First, let us observe that, for a fixed s ∈ [symbol] ({1, . . . , n}), every gate in A ∈ Oₛ commutes with every gate in Ōₛ that originally appears later than [symbol] , as there are no common qubits that they act on. This implies that Oᵤ=Oₛ∘Õs, for all s ∈ [symbol] ({1, . . . , n}).

Similarly Uⱼ and Õ_{d(j)} commute, as there are no common qubits that they act on, j=1, . . . , [symbol] .

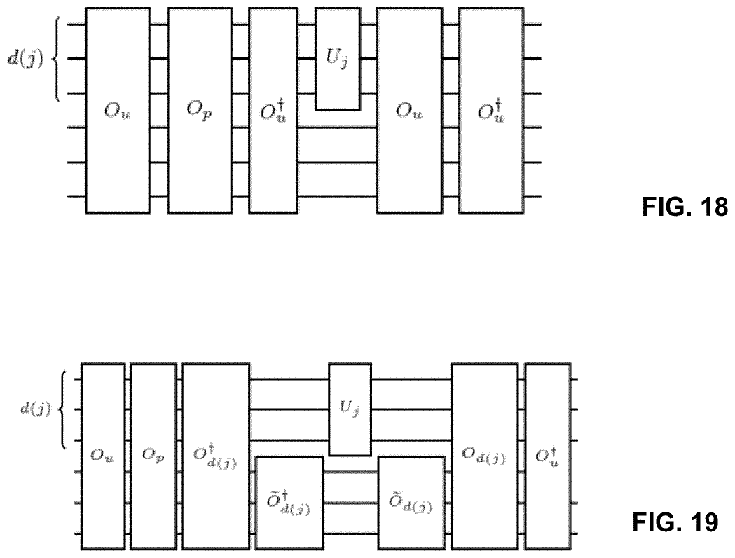

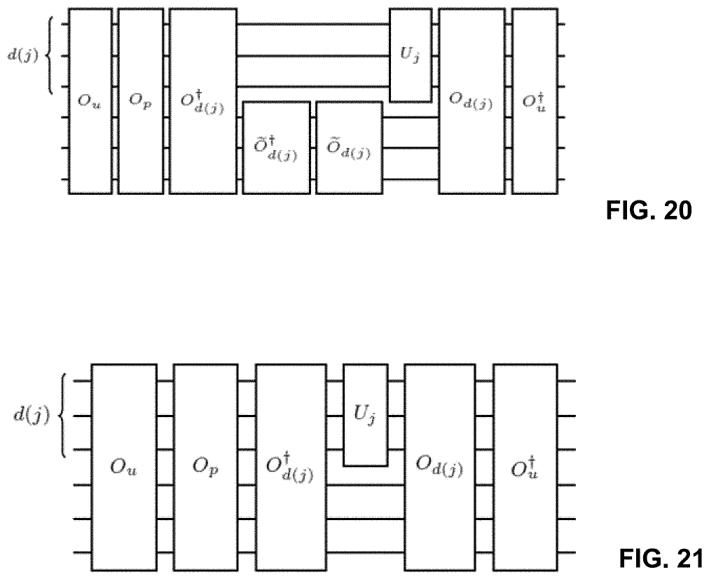

We now proceed to apply these properties to V( [symbol] , d, U, O) in order to obtain \acute{V}. This will happen in the following five steps.
1. Append an identity Oᵤ^{†}∘Oᵤ operation to each factor of V( [symbol] , d, U, O),
   see FIG. 18 which presents a graphical representation of the jth factor after applying step (1). For simplicity we assumed that d(j) consists of first |d(j)| qubits.
2. Express Oᵤ (resp. Oᵤ^{‡}) occurring next to Uⱼ as O_{d(j)}∘Õ_{d(j)} (resp. Õ_{d(j)}^{†}∘Õ_{d(j)}^{\} in the jth factor, j ϵ (1, . . . , [symbol] }, see FIG. 19 which presents a graphical representation of the jth factor after applying step (2). For simplicity we assumed that d(j) consists of first |d(j)| qubits.
3. Swap Õ_{d(j)} and Uⱼ in the jth factor, j ∈ {1, . . . , [symbol] ),
   see FIG. 20 which presents a graphical representation of the jth factor after applying step (3). For simplicity we assumed that d(j) consists of first |d(J)| qubits.
4. Remove the identity operation Õ_{d(j)}^{†}∘Õ_{d(j)} in the jth factor, j ∈ 55 1, . . . , [symbol] },

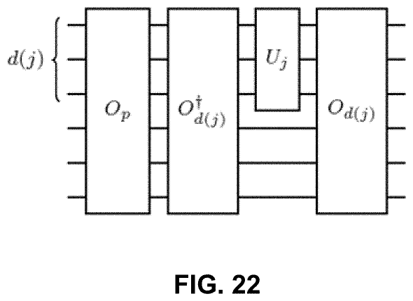

see FIG. 21 which presents a graphical representation of the jth factor after applying step (4). For simplicity we assumed that d(j) consists of first |d(j)|qubits.
5. Remove the identity operation Oᵤ∘Oᵤ^{†} on the boundary between each two consecutive factors, see FIG. 22 which presents a graphical representation of the jth factor after applying step (4). For simplicity we assumed that d(j) consists of first |d(j)| qubits.

More concisely we put:

$$\tilde{V} := O \text{?} ∘ {{\prod }_{j = 1}}^{ℓ} ( {O}_{d ( j )} ∘ {U}_{j} ∘ {O}_{d ( j )} \text{?} ∘ {O}_{p} ) ∘ {O}_{u} .$$

$$\text{?} \text{indicates text missing or illegible when filed}$$

As discussed above V( [symbol] , d, U, O) and \tilde{V} are equal as unitary operators. The desired gate count follows directly from the definition. [symbol]
Corollary 32. Let (Oᵤ, Oₚ) be an uncomputable decomposition of O and let Dᵤ, and Dₚ, be the total number of gates used in Oᵤ, and Oₚ, respectively, Let Dᵢ be the number of gates within Oᵤ that depend on the ith qubit, i ∈ {(1, . . . , n} and let D̅ⱼ be the average of Dᵢ taken over the qubits i ∈ d(j), i.e., the average number of gates within Oᵤ that depend on a single qubit from the d(j), j=1, . . . , [symbol] ,

For a given generic oracle circuit V( [symbol] , d, U, O) one can implement an equivalent circuit \tilde{V} that uses no more than the following average number of gates per oracle query:

$${D}_{p} + 2 \frac{{D}_{u} + {\sum }_{j = 1}^{ℓ} \vert d ( j ) \vert {\overline{D}}_{j}}{ℓ} .$$

Proof. This follows directly from Theorem [symbol] and the fact that the number of gates that depend on any of the qubits from a given set is no greater that the sum of the numbers of gates that depend on individual qubits from this set. [symbol]
Corollary 33. Let (Oᵤ, Oₚ) be an uncomputable decomposition of O and let Dᵤ, and Dₚ, be the total number of gates used in Oᵤ, and Oₚ, respectively. Let D [symbol] be the number of gates within Oᵤ that depend on the th qubit, i ∈ {1, . . . , n} and let D be the average of Dₛ taken over all qubits i ∈ {1, . . . , n}.

For a given generic oracle circuit V( [symbol] , d, U, O) one can implement an equivalent circuit \tilde{V} that uses no more than the following average number of gates per oracle query:

$${D}_{p} + \frac{2 {D}_{u}}{ℓ} + 2 D \frac{{\sum }_{j = 1}^{ℓ} \vert d ( j ) \vert}{ℓ} .$$

In particular, one can implement a circuit equivalent to Wₘ that uses an average of no more than the following number of gates per oracle query:

$${D}_{p} + \frac{4 {D}_{u}}{{3}^{m} - 1} + 4 D \frac{{\sum }_{j = 1}^{m} {k}_{j} {3}^{m -}}{{3}^{m} - 1} .$$

Using the notation of Theorem [symbol] this asymptotic average number of gates is [symbol] (Dₚ+log(1/ε) D.
Proof. Without loss of generality, we may assume that (Dₜ)ₜ₌₁ [symbol] is non-decreasing. Similarly, without loss of generality, we may assume that the weights ω [symbol] =|{(j ∈ {1, . . . , [symbol] }: i ∈ d(j)}|/ [symbol] , i=1, . . . , n of subsequent qubits form a non-increasing sequence. Then a weighted average of Dₜs:

$$\frac{{\sum }_{i = 1}^{n} {w}_{i} {D}_{i}}{{\sum }_{i = 1}^{n} {w}_{i}} = \frac{{\sum }_{j = 1}^{ℓ} \sum \text{?} {D}_{i}}{ℓ {\sum }_{i = 1}^{n} {w}_{i}} = \frac{{\sum }_{j = 1}^{ℓ} \vert d ( j ) \vert {\overline{D}}_{j}}{{\sum }_{j = 1}^{ℓ} d ( j )}$$

$$\text{?} \text{indicates text missing or illegible when filed}$$

will not be greater than their arithmetic mean D. This completes the first part of the proof. To obtain bound for circuit Wₘ, recall from section [symbol] that [symbol] =(3^{m}−1)/2 and that j-th diffuser (of size kⱼ) appears in Wₘ exactly 3^{m-j} times, so [symbol] ₌₁|d(j)|=Σⱼ₌₁^{m}kⱼ3^{m-j}.

For the asymptotic result, recall from the proof of Theorem [symbol] (eq. [symbol] ) that (after setting x ∈ θ(log(1/ε)) as in the proof) we have m=θ(\sqrt{n/log(1/ε)}) and we invoke the Wₘ circuit [symbol] /2^{n/2}/3^{m}) times with parameters kⱼ≤3┌log₂(1/ε)┐j, j ∈ {1, . . . , m}. Additionally, observe that

$${\sum }_{j = 1}^{m} j {3}^{m - j} = {\sum }_{j = 1}^{m} \frac{{3}^{m - j + 1} - 1}{2} = \frac{3}{4} ( {3}^{m} - 1 ) - \frac{m}{2} = 𝒪 ( {3}^{m} - 1 ) .$$

As each amplitude amplification step requires additional [symbol] (n+Dₚ+Dᵤ) gates, we get that the asymptotic average number of gates is

Dₚ+ [symbol] (Dᵤ/3^{m})+log(1/ε) [symbol] (D)+ [symbol] ((n+Dₚ+Dᵤ)/3^{m})= [symbol] (Dₚ+log(1/ε)D).

[symbol]

Corollary 34. Let K ∈ [symbol] and consider all Unique k-SAT instances, each with n variables and c clauses. For each such an instance there exists a circuit equivalent to Wₘ that uses an average of no more than the following number of gates per query:

$$1 + \frac{12 Ke + 8 e - 4}{{3}^{m} - 1} + \frac{4 Ke ( 4 + ⌈ {log}_{2} K ⌉ + ⌈ {log}_{2} e ⌉ )}{n} \cdot \frac{{\sum }_{j = 1}^{m} {k}_{j} {3}^{m -}}{{3}^{m} - 1} .$$

Using the notation of Theorem [symbol] the asymptotic average per-oracle-query number of gates of a quantum circuit solving Unique k-SAT with certainty is [symbol] (log(1/ε)e log(e)/n)
Proof. A straightforward implementation of the phase oracle O consists of Dᵤ≤3Ke+2c−1. gates (each being an X, a CX, or a CCX) in the uncomputable part and one Z gate (Dₚ=1) in the phase part.

More precisely, we introduce the following ancilla qubits and the gates to compute them:
1. c qubit groups of K qubits corresponding to negation of all clause literals, each computed by one CX and at most one X,
2. c qubit groups of K−1 qubits corresponding to conjunctions of qubits from (1), each computed by one CCX. They are arranged into a binary tree, so that only ┌log₂ K┐ gates depend on every qubit of (1).
3. e qubits corresponding to all clauses, each computed by one CX and one X from a top-level qubit of (2).
4. c−1 qubits corresponding to conjunctions of qubits from (3), each computed by one CCX. Again, they are arranged into a binary tree, so that only ┌log₂c┐ gates depend on every qubit from (3).

For a variable v appearing in cᵥ clauses, the number of gates depending on v is at most c_{ε}(2+┌log₂K┐+2+┌log₂e┐), so we get the average D≥Kc(4+┌log K┐+┌log₂c┐)/n.

By Corollary [symbol] we get both claims. [symbol]
Corollary 4. Consider the Unique k-SAT problem with n variables and e clauses. There exists a quantum circuit that uses [symbol] (c log(c)2^{n/2}/n} total (oracle and non-oracle) gates and solves the problem with certainty.
Proof. This follows directly from Theorem [symbol] Corollary

[symbol]

[symbol]

### VI. Multipoint Oracle

We now proceed to the unstructured search problem with multiple marked elements. As in previous sections we assume that number of qubits in the input of the oracle is n. Let S he the set of elements marked by oracle O and let K=|S|>0. For convenience we mostly refer to the number k=1+┌log₂ K┐. We begin our investigation with the assumption that k is known in advance and later proceed to consider the harder case of unknown k.

### A. Known Number of Marked Elements

In this section we assume that value k is known. It is weaker assumption than knowing K but it is sufficient for our purpose.

We use algorithm from Theorem [symbol] as a subroutine in algorithms in this section. By SinglePoint(O, n) we denote the algorithm from Theorem [symbol] that solves unstructured search problem for oracle O which marks exactly one element and acts on n qubits. We want to reduce the problem of unstructured search with possibly many elements marked to the unstructured search with one marked element. To do this we construct a family of hash functions that allows us to effectively parametrize a subset of {0,1}ⁿ which with high probability contains only one element from S. This technique is nearly identical to reduction from SAT to Unique SAT presented in [symbol] . Next, we improve some aspects of this reduction, so that methods of partial uncompute may be used to reduce the number of additional non-oracle basic gates.

Let us recall that family U of hash functions from X to Y, both being finite is called pairwise independent if for every x ∈ X and every y ∈ Y we have:

$${ℙ}_{h ∈ {n}^{U}} ( h ( x ) = y ) = \frac{1}{\vert Y \vert}$$

and for every x₁, x₂ ∈ X, x₁≠x₂ and every y₁,y₂ ∈ Y we have:

$${ℙ}_{h ∈ {n}^{U}} ( h ( {x}_{1} ) = {y}_{1} ⋀ h ( {x}_{2} ) = {y}_{2} ) = \frac{1}{{\vert Y \vert}^{2}} .$$

We use the following formulation of results from [symbol] that can be found in [symbol] , p9.10 (180)|.

Lemma 35 (Valiant-Vazirani). For any family of pairwise independent hash functions H from {0,1}ⁿ to {0, 1}^{k} and S ⊂{0, 1}ⁿ such that 2^{b-2}≤|S|≤2^{k-1} we have that

$${ℙ}_{h ∈ {n}^{H}} ( \vert \{ x ∈ S : h ( x ) = 0 \} \vert = 1 ) \geq \frac{1}{8}$$

A function h: {0, 1}^{m}→{0, 1}^{l} is called affine if we may represent it as h(x) Ax+b for some A ∈ {0, 1}^{l×m} and b ∈ {0, 1}^{l}. All arithmetical operations are performed modulo 2.

The kernel of the affine function h:{0, 1}^{m}→{0, 1}^{l} of the form h(x) Ax+b is defined as ker h=h⁻¹(0). Whenever the kernel of the affine function h is notan empty set, we define the dimension of this kernel as dim ker h=dim ker A. Where ker A is the null space of the matrix A.

Whenever function h is clear from the context we will use d=dim ker h for brevity. Our choice of the family of hash functions is as follows.

Definition 36. Define a family of hash functions H_{n,k} as the set of all affine maps from {0,1}ⁿ to {0, 1}^{k}:

H_{n,k}:={h_{A,b}: A∈{0,1}^{k×n},b∈{0,1}^{k},h_{A,b}(x)=Ax+b}

The first mention of this family is in [symbol] , more detailed considerations can be found in [symbol] . The following standard result will be of use to us.

Observation 37 (Folklore). The family H_{n,k} is pairwise independent.

We would like to run algorithm SinglePoint on the set ker h. To do so we parametrize ker h by some injection g:{0, 1}^{dim ker h}→ker h and build a quantum oracle Oₙ defined as follows.

Definition 38. Given a quantum oracle O:( [symbol] ²)³ⁿ→( [symbol] ²)³ⁿ, and any function g: {0, 1}^{d}→{0, 1}ⁿ we define the g-restricted oracle O_{g} as:

O_{q}=D_{g}⁻¹Id_{d}⊗O)D_{g},

where D_{g} is a unitary operator on ( [symbol] ²)^{⊗(d-i-n)} whose action on states |i [symbol] 0 . . . 0 [symbol] for i ∈ {0, 1}^{d} is defined as

D^{g}|i [symbol] |0 . . . 0 [symbol] =|i [symbol] |g(i)

[symbol]

Observation 39. If oracle O admits uncomputable decomposition (Oᵤ, Oₚ) then for any function g:{0, 1}^{d}→{0, 1}ⁿ the g-restricted oracle O_{g} admits an uncomputable decomposition ((Id_{d}⊗Oₛ)D_{g}, Id_{d}⊗Oₚ).
Proof, it follows directly from definition

$${O}_{g} = {D}_{g}^{- 1} ( {Id}_{d} ⊗ O ) {D}_{g} = {D}_{g}^{- 1} ( {Id}_{d} ⊗ {O}_{u}^{- 1} ) ( {Id}_{d} ⊗ {O}_{p} ) ( {Id}_{d} ⊗ {O}_{u} ) {D}_{g} = {( ( {Id}_{d} ⊗ {O}_{u} ) {D}_{g} )}^{- 1} ( {Id}_{d} ⊗ {O}_{p} ) ( ( {Id}_{d} ⊗ {O}_{u} ) {D}_{g} ) .$$

Lemma 40. For an affine injection function g:{0, 1})^{d}→ker h of the form g(x)=Cx+p, where C=(cᵢⱼ) we can Construct D_{g} using basic quantum gates so that the number of gates that depend on J-th qubit of the first register is exact equal to |({i:cᵢⱼ=1}|.
Proof. It is easy to see that D_{g} can be implemented using gates CX(ƒⱼ, sₜ) where ƒⱼ is the j-th qubit of the first register and sₜ is the i-th qubit of the second register for each i, j such that (cᵢⱼ=1 and using gates X (sₜ) for all i such that pₜ>0. >

[symbol]

Now we are ready to construct g which effectively parametrizes ker h.

Lemma 41. Given an affine function h:{0, 1}ⁿ→{0, 1}^{k} of the form h(x)=Ax+b with ker h≠0 we may construct in polynomial time an injective function g:{0, 1}^{d}→{0, 1}ⁿ of the form g(x)=Cx+p for some C ∈ {0, 1} [symbol] ×d, p ∈ {0, 1}ⁿ, and d, where d=dim ker h, such that Im g=ker h. Moreover, we may choose C so that each of its columns has at most n−d+1 ones.
Proof. We begin by obtaining an arbitrary affine parametrization of ker h. To this end fix some basis of ker A, arrange it as columns into the matrix C′ and any solution p to the equation Ax=−b. All of this can be accomplished in polynomial time using Gaussian elimination [symbol] . Setting ƒ(x)=C′x+p gives us the desired parametrization.

To reduce number of ones in the matrix C′, we can change basis of domain of ƒ by an invertible matrix Q ∈ {0, 1}^{d×d}. As function ƒ is an injection, matrix C′ has d rows which are linearly independent and they form an invertible submatrix Cⁿ. By picking Q=(Cⁿ)⁻¹ we assure that for each column of matrix C′Q at most one row among those d picked previously has one which is contained in this column. After these steps we end up with a function g of the form g(x)=C′Qx+p, where each column of C=C′Q has at most n−d+1 non-zero entries.

[symbol]

As we parametrize the kernel of random affine map we want to make sure that dimension of this kernel is nor too big, as the number of oracle queries and the number of non-oracle basic gates used by singlePoint depends exponentially on the dimension of the searched space.

[symbol]

Proof. We prove the more general inequality [symbol] k<n−2 and any natural c≥2. Set δ=k−c. If δ<0 then the conclusion follows trivially. Otherwise the event dim ker h≥n−k+e is equivalent to n−δ=n−k+c≤dim ker h=dim ker A=n−rank A so we conclude rank A≤δ, meaning that vector subspace spanned by rows of matrix A must have dimension at most δ.

As vectors that span subspace of dimension at most δ are contained in some δ-dimensional subspace of {0, 1}ⁿ we can consider the probability of all k vectors being contained in a particular δ-dimensional subspace. Then we apply union bound by multiplying this probability by the number of δ-dimensional subspaces. The probability of choosing all k vectors from a single δ-dimensional space is

$${( \frac{1}{\text{?}} )}^{k} ,$$

$$\text{?} \text{indicates text missing or illegible when filed}$$

as δ-dimensional space contains 2^{δ} elements and we choose those vectors independently from each other. Let us recall that a number of δ-dimensional subspaces of n dimensional space over [symbol] ₂ equals

$$\text{?}$$

$$\text{?} \text{indicates text missing or illegible when filed}$$

this can be found in [symbol] .

So using the union bound the probability that k vectors span at most δ-dimensional subspace is bounded from above by:

$$\text{?}$$

$$\text{?} \text{indicates text missing or illegible when filed}$$

where the last inequality follows from Euler's pentagonal numbers theorem [symbol] . The final expression is less than

$$\text{?} for e \geq 2$$

$$\text{?} \text{indicates text missing or illegible when filed}$$

and n−k>2.

[symbol]

Now we may describe the algorithm for solving unstructured search problem with known value k=┌log₂ K┐ where K is the number of marked elements.

ALGORITHM 1
Probabilistic algorithm for solving unstructured
search with known k

| | |
|---|---|
| 1: | procedure MULTIPOINT(O, n, k} |
| 2: | if k ≥ n − 2 then |
| 3: | [symbol] ← clement from {0, 1}ⁿ selected uniformly at random |
| 4: | if [symbol] is marked then |
| 5: | return x |
| 6: | end if |
| 7: | return null |
| 8: | end if |
| 9: | h ← random affine transformation from H_{n,k} |
| 10: | d ← dim ker h |
| 11: | if d ≥ n − k + 2 then |
| 12: | return null |
| 13: | end if |
| 14: | O_{g} is built as described in Definition [symbol] using g from Lemma [symbol] |
| 15: | return SinglePoint(O_{g}, d) |
| 16: | end procedure |

[symbol]

indicates data missing or illegible when filed

Theorem 6. Let N ∈ [symbol] be of the form N=2ⁿ. Assume that we are given a phase oracle O that marks K elements, and we know the number k given by k=1+┌log₂ K┐. Then one can find an element marked by O with probability at least

$$\frac{1}{16}$$

using at most

$$𝒪 ( \sqrt{\frac{N}{K}} )$$

oracle queries and at most

$$𝒪 ( log K \sqrt{\frac{N}{K}} )$$

non-oracle basic gates.
Proof. To prove that Algorithm [symbol] finds a marked element with constant probability, let us see that if k≥n−2, then selecting a random element succeeds with probability at least

$$\frac{1}{16}$$

Otherwise, from Lemma [symbol] with probability at least ⅛ we have that |K∩ker h|=1.

From Lemma [symbol] with probability at least

$$\frac{15}{16}$$

we have that d<n−k+2. Combining those facts we obtain that with probability at least

$$\frac{1}{16}$$

oracle O_{g} marks exactly one element and the number of qubits of its input does not exceed n−k+1. So Algorithm [symbol] succeeds with probability at least

$$\frac{1}{16}$$

as from Theorem [symbol] know that SinglePoint solves the unstructured problem with one marked element with certainty.
From Lemma [symbol] and Lemma [symbol] we deduce that at most [symbol] (k) additional basic gates from circuit D_{g} depend on each qubit. So from Corollary [symbol] we deduce that on average we use [symbol] (k) additional non-oracle basic gates per oracle query. There are

$$𝒪 ( \sqrt{\frac{N}{K}} )$$

oracle queries in SinglePoint procedure so we need

$$𝒪 ( k {2}^{\frac{n - k}{2}} ) = 𝒪 ( log K \sqrt{\frac{N}{K}} )$$

non-oracle gates to implement it. [symbol]
Proposition 43. For any p ∈ (0, 1) by repeating Algorithm

[symbol]

$$𝒪 ( log \frac{1}{1 - p} )$$

number of times we assure that we find a marked element with probability at least p.
Proof. We may deduce that from the fact that all runs of this algorithm are independent and each finishes successfully with constant, non-zero probability.

[symbol]

Let us for any probability p<1 define an algorithm MultiPointAmplified (O, n, k, p) which runs algorithm MultiPoint (O, n, k) minimal number of times to ensure probability of success higher than p.

### B. Unknown Number of Marked Elements

The technique presented next is similar to one used in [symbol] , which finds element marked by an oracle O using on average

$$𝒪 ( {2}^{\frac{n - k}{2}} )$$

calls to oracle O and on average

$$𝒪 ( n 2 \text{?} )$$

$$\text{?} \text{indicates text missing or illegible when filed}$$

additional basic gates. We improve those result and propose the following algorithm that finds marked element using

$$𝒪 ( k 2 \text{?} )$$

$$\text{?} \text{indicates text missing or illegible when filed}$$

non-oracle gates in expectation and makes

$$𝒪 ( 2 \text{?} )$$

$$\text{?} \text{indicates text missing or illegible when filed}$$

queries to oracle O also in expectation.

ALGORITHM 2
Probabilistic algorithm for solving unstructured search problem
without an estimate of the number of marked elements

| | |
|---|---|
| 1: | procedure MULTIPOINT (O, n, p) |
| 2: | for i ← n + 2 to 2 do |
| 3: | for j ← n + 2 to i do |
| 4: | x ← MultiPointAmplified(O, n, j, p) |
| 5: | if x is marked then |
| 6: | return x |
| 7: | end if |
| 8: | end for |
| 9: | end for |
| 10: | end procedure |

Before we analyze Algorithm [symbol] we note an observation:

Observation 44. For natural numbers x and m, and any real number r, such that x≤m and r>1, we have

$${\sum }_{l = 0}^{x} ( m - l ) {r}^{1 / 2} - ( m - x ) {\sum }_{l = 0}^{x} {r}^{1 / 2} + {\sum }_{l = 0}^{x} ( x - l ) {r}^{1 / 2}$$

$$= ( m - x ) {r}^{x / 2} {\sum }_{l = 0}^{x} {r}^{( l - x ) / 2} + {r}^{z / 2} {\sum }_{l = 0}^{x} ( x - l ) {r}^{( l - z ) / 2}$$

$$\leq ( m - x ) {r}^{x / 2} {\sum }_{l = 0}^{∞} {r}^{- 1 / 2} + {r}^{x / 2} {\sum }_{l = 0}^{∞} {ir}^{- 1 / 2} = {C}_{1} ( m - x ) {r}^{x / 2} + {C}_{2} {r}^{x / 2}$$

Where C₁,C₂ are positive constants which depend only on r.
Observation 45. For natural numbers x and m, and any real number r, such that x≤m and r<1, we have

$${\sum }_{l = 0}^{x} ( m - l ) {r}^{1 / 2} \leq Cm$$

where C is a positive constant which depends only on r.
Theorem 46. For p satisfying 2(1−p)²<1 the Algorithm [symbol] finds marked elements with probability at least 1−(1−p)^{k}. Its expected number of oracle queries is

$$𝒪 ( \sqrt{\frac{N}{K}} )$$

and its expected number of non-oracle basic gates is

$$𝒪 ( log K \sqrt{\frac{N}{K}} ) ,$$

where N=2ⁿ is the size of the search space and K is the number of elements marked by the oracle and k=1+┌log₂ K┐.
Proof. In the complexity analysis we consider two phases of the Algorithm [symbol] The first phase is when i>k. During this phase we never run algorithm MultiPointAmplified (O, n, j, p) with j=k, so let us assume that this algorithm never finds marked element in this phase.

In the second phase i e. for i<k in each inner loop we run the procedure MultiPointAmplified (O, n, j, p) with j=k once, so during this loop we find marked element with probability at least p. So the probability that outer loop proceeds to the, next iteration is at most 1−p. So overall bound on expected number of oracle queries of this algorithm is given below, we also note that all constants hidden under big [symbol] notation depend either only on p or are universal:

$$𝒪 ( {\sum }^{n + 2} \text{?} \sum \text{?} 2 \text{?} + \sum \text{?} ( 1 - p ) \text{?} \sum \text{?} 2 \text{?} )$$

$$= 𝒪 ( {\sum }^{n} \text{?} {\sum }^{n} \text{?} 2 \text{?} + {\sum }^{k} \text{?} ( 1 - p ) \text{?} {\sum }^{n} 2 \text{?} )$$

$$= 𝒪 ( {\sum }^{n} \text{?} \sum \text{?} 2 \text{?} + \sum \text{?} ( 1 - p ) \text{?} \sum \text{?} 2 \text{?} ) = 𝒪 ( \sum \text{?} 2 \text{?} + \sum \text{?} ( 1 - p ) \text{?} 2 \text{?} )$$

$$= 𝒪 ( {\sum }^{n - k} \text{?} 2 \text{?} + 2 \text{?} \sum \text{?} ( 2 {( 1 - p )}^{2} ) \text{?} ) = 𝒪 ( 2 \text{?}$$

$$\text{?} \text{indicates text missing or illegible when filed}$$

To estimate the second summand we use the fact that 2(1−p)²<1. Using Observation [symbol] and Observation [symbol] we calculate the similar bound for the number of additional non-oracle basic gates, also take a note, that hidden constants below depend only on p or are universal:

$$𝒪 ( {\sum }^{n + 2} \text{?} {\sum }^{n + 2} \text{?} j {2}^{( n - j ) / 2} + {\sum }^{k} \text{?} ( 1 - p ) \text{?} {\sum }^{n + 2} j {2}^{( n - j ) / 2} ) =$$

$$𝒪 ( {\sum }^{n} \text{?} {\sum }^{n} \text{?} j {2}^{( n - j ) / 2} + {\sum }^{k} \text{?} ( 1 - p ) \text{?} {\sum }^{n} \text{?} j {2}^{( n - j ) / 2} )$$

$$= 𝒪 ( {\sum }^{n} \text{?} \sum \text{?} ( n - l ) 2 \text{?} + \sum \text{?} ( 1 - p ) \text{?} \sum \text{?} ( n - l ) 2 \text{?} ) = 𝒪 ( {\sum }^{n} i 2 \text{?} + {\sum }^{k} \text{?} i ( 1 - p ) \text{?} 2 \text{?} )$$

$$= 𝒪 ( {\sum }^{n - k} ( n - s ) 2 \text{?} + {2}^{( n - k ) / 2} \sum \text{?} ( k - s ) ( 2 {( 1 - p )}^{2} ) \text{?} ) = 𝒪 ( k 2 \text{?} )$$

$$\text{?} \text{indicates text missing or illegible when filed}$$

So the complexity of the algorithm does not change even if the number of elements is not known beforehand. To calculate the probability of successfully finding the marked element let us see that the outer loop runs less than n+1 times only when the marked element was found. From the above considerations we know that this probability is bounded from below by 1−(1−p)^{b}.

[symbol]

### ACKNOWLEDGMENTS

We would like to express our deep gratitude to our friends at Beit, in particular to Wojciech Burkot, for their insights and criticism. However, mere language would not suffice for this endeavour, so we will refrain from doing so.
[1] Sanjeev Arora and Boaz Barak. Computational Complexity: A. Modern Approach. Cambridge University Press. USA, 1st edition, 2009.
[2] Srinivasan Arunachalam and Ronald de Wolf. Optimizing the number of gates in quantum search. arXiv preprint arXi:1512.07550, 2015.
[3] Michel Boyer, Gilles Brassard, Peter Hayer, and Alain Tapp. Tight bounds on quantum searching. Fortschritte der Physik, 46(4-5):493-505, June 1998.
[4] Gilles Brassard, Peter Hayer, Michele Mosca, and Alain Tapp. Quantum amplitude amplification and estimation. Contemporary Mathematics, 305:53 74, 2002.
[5] Gilles Brassard, Peter Hayer, and Alain Tapp. Quantum cryptanalysis of hash and claw-free functions. Lecture Notes in Computer Science, page 163-169, 199.
[6] Wojciech Burkot, Jan Tulowiecki, Vladyslav Hembotskyi, and Witold Jarnicki. Quantum circuit and methods for use therewith. March 2020. U.S. patent application No. 62,990,122.
[7] Chris Calabro, Russell Impagliazzo, Valentine Kabanets, and Ramamohan Paturi. The complexity of unique k-sat: An isolation lemma for k-enfit. Journal of Computer and System Science, 74(3):386-393, 2008.
[8] J. Lawrence Carter and Mark N. Wegman. Universal classes of hash functions. Journal of Computer and System Science, 18(2):143-154, 1979.
[9] Christoph Darr and Peter Hayer. A quantum algorithm for finding the minimum, 1996.
[10] Christopher Dûrr, Mark Heiligman, Peter Hayer, and Mehdi Mhalla. Quantum query complexity of some graph problems. SIAM Journal on Computing. 35(6):1310-1328, January 2006.
[11] Leonhard Enler. Evolutio producti infiniti (1−x)(1−xx)(1−x³)(1−x4)(1−x⁵)(1−x⁶) etc. in seriem simplicem. Acta Academiae Scientarum Imperialis Petropolitinae, pages 47-44, 1783.
[12] Jay Goldman and Gian-Carlo Rota. On the foundations of combinatorial theory iv finite vector spaces and eulerian generating functions. Studies in Applied Mathematics. 49(3):239-258, 1970.
[13] Lov K. Grover. A fast quantum mechanical algorithm for database search. In Proceedings of the twenty-eight annual ACM symposium on Theory of computing, page 212-219. 1996.
[14] Lov K. Grover. Trade-offs in the quantum search algorithm. Physical Review A, 66(5):052314, 2002.
[15] Jan Cwinner, Marcin Briariski, Wojciech Burkot, Lukasz Czerwinski, and Vladyslav Hlembotskyi. Benchmarking 16-element quantum search algorithms on ibm quantum processors, 2020.
[16] A. Mandviwalla, K. Obshiro, and B. Ji. Implementing grover's algorithm on the ibm quantum computers. In 2018 IEEE International Conference on Big Data (Big Data), pages 2531-2537. 2018.
[17] Yishay Mansour, Noam Nisan, and Prasoon Tiwari. The computational complexity of universal hashing. Theoretical Computer Science, 107(1):121-133. 1993
[18] M. Thamban Nair and Arindama Singh. Elementary operations. In Linear Algebra, pages 107-161. Springer, 2018.
[19] Michael A. Nielsen and Isaac Chuang, Quantum computation and quantum information. American Journal of Physics, 70(5):558-559, 2002.
[20] L. G. Valiant and V. V. Vazirani. Np is as easy as detecting unique solutions. In Proceedings of the Seventeenth Annual ACM Symposium on Theory of Computing, STOC '85, page 458-463. New York, N.Y. USA, 1985. Association for Computing Machinery.
[21] Christof Zalka, Grover's quantum searching algorithm is optimal. Physical Review A, 60(4):2746-2751, October 1999.
[22] Kun Zhang and Vladimir E. Korepin. Depth optimization of quantum search algorithms beyond grover's algorithm. Physical Review A, 101(3), March 2020.

Addendum to Appendix I: Analysis of the Tree Circuit

Due to limited nature of existing hardware, for small search spaces the circuits Wₘ are outperformed by a similar family of circuits, which we denote by Dₘ. The circuits were experimentally evaluated on current generation of superconducting quantum computers. The results are presented in [symbol] . For the sake of completeness we prove an analogue of Theorem [symbol] that utilises the Dₘ, family of circuits.

Definition 47. Let k̅=(k₁, . . . , kₘ) be a sequence of positive integers and let n:=Σⱼ₌₁^{m}kⱼ. Given a quantum oracle O, for j ∈ {0, . . . , m} we define the circuit Dⱼ recursively as follows:

$${D}_{j} = \{ \begin{matrix}{Id}_{n} & if j = 0 \\ {D}_{j - 1} \cdot ( Id \text{?} ⊗ G \text{?} ⊗ Id \text{?} ) \cdot O \cdot {D}_{j - 1} & if j \neq 0\end{matrix} .$$

$$\text{?} \text{indicates text missing or illegible when filed}$$

Lemma 48. Let m ∈ [symbol] ₊ and k̅ ∈ [symbol] ₊^{m} be fixed, and let n=Σⱼ₌₁^{m}kⱼ. Assume we are given a phase oracle O that operates on n qubits and marks a single vector of the standard computational basis, which we then use in the circuits Dⱼ. Then for any j ∈{0, . . . , m} we have

DⱼODⱼ=O

Proof. We proceed by induction on j. For j=0 the claim is trivial. For j>0 we expand Dⱼ according to Definition [symbol] as follows

$${D}_{j} {OD}_{j} = {D}_{j - 1} ( Id \text{?} ⊗ G \text{?} ⊗ Id \text{?} ) {OD}_{j - 1} {OD}_{j - 1} ( Id \text{?} ⊗ G \text{?} ⊗ Id \text{?} ) {OD}_{j - 1} \qquad ( A1 )$$

$$= {D}_{j - 1} ( Id \text{?} ⊗ G \text{?} ⊗ Id \text{?} ) OO ( Id \text{?} ⊗ G \text{?} ⊗ Id \text{?} ) {OD}_{j - 1}$$

$$= {D}_{j - 1} ( Id \text{?} ⊗ G \text{?} ⊗ Id \text{?} ) ( Id \text{?} ⊗ G \text{?} ⊗ Id \text{?} ) {OD}_{j - 1}$$

$$= {D}_{j - 1} {OD}_{j - 1}$$

$$= O \qquad ( A2 )$$

$$\text{?} \text{indicates text missing or illegible when filed}$$

where in es. ( [symbol] ) and ( [symbol] ) we used the inductive hypothesis.□
Lemma 49. Let m ∈ [symbol] ₊ and k̅ ∈ [symbol] ₊^{m} be fixed, and let n=Σⱼ₌₁^{m}kⱼ. Assume we are given a phase oracle that operates on n qubits and mark a single vector of the standard computational basis denoted target Define the numbers

βⱼ=(target|(Dⱼ|u₁^{j} [symbol] |targetⱼ₊₁^{m} [symbol] )

for j ∈ {0, . . . , m}. Then βⱼ satisfy the recurrence

$$β \text{?} = \{ \begin{matrix}1 , & if j = 0 \\ \frac{1}{2 \text{?}} ( 1 - \text{?} ) + \frac{1}{2 \text{?}} ( 2 - \text{?} ) {β}_{j - 1} , & if j > 0\end{matrix} .$$

$$\text{?} \text{indicates text missing or illegible when filed}$$

Proof By definition of Dⱼ we have β₀=1 giving the base case. For j>0, we proceed to compute βⱼ by expanding the circuit Dⱼ according to the recursive definition. We split the computation into stages as follows

|ω₁ [symbol] =Dⱼ₋₁(|u₁^{j} [symbol] |targetⱼ₊₁^{m} [symbol] )

|ω₂ [symbol] =O|ω₁

[symbol]

|ω₃ [symbol] =(Idₛ₋ₖ_{ⱼ}⊗Gₖ_{ⱼ}⊗Idₙ₋ₐ)|ω₂

[symbol]

|ω₄ [symbol] =Dⱼ₋₁|ω₃

[symbol]

where s=k₁+ . . . +kⱼ.

$$\vert {w}_{1} 〉 = {D}_{j - 1} ( \frac{1}{2 \text{?}} \vert {u}_{1}^{j - 1} 〉 \vert {target}_{j}^{m} 〉 + \vert u \text{?} 〉 \vert \overline{{target}_{j}} 〉 \vert {target}_{j + 1}^{m} 〉 )$$

$$= \frac{1}{2 \text{?}} {D}_{j - 1} \vert {u}_{1}^{j - 1} 〉 \vert {target}_{j}^{m} 〉 + \vert {u}_{1}^{j - 1} 〉 \vert \overline{{target}_{j}} 〉 \vert {target}_{j + 1}^{m} 〉$$

$$\vert {w}_{2} 〉 = O ( \frac{1}{2 \text{?}} {D}_{j - 1} \vert {u}_{1}^{j - 1} 〉 \vert {target}_{j}^{m} 〉 + \vert {u}_{1}^{j - 1} 〉 \vert \overline{{target}_{j}} 〉 \vert {target}_{j + 1}^{m} 〉 )$$

$$= \frac{1}{2 \text{?}} {OD}_{j - 1} \vert {u}_{1}^{j - 1} 〉 \vert {target}_{j}^{m} 〉 + \vert {u}_{1}^{j - 1} 〉 \vert \overline{{target}_{j}} 〉 \vert {target}_{j + 1}^{m} 〉$$

$$= \frac{1}{2 \text{?}} \vert η 〉 \vert {target}_{j}^{m} 〉 + \vert {u}_{1}^{j - 1} 〉 \vert \overline{{target}_{j}} 〉 \vert {target}_{j + 1}^{m} 〉$$

$$\text{?} \text{indicates text missing or illegible when filed}$$

Where |η [symbol] is some state in ( [symbol] ²)^{⊗(k}^{₁}^{+ . . . +k}^{_{j−1}}⁾. We can write so, as all diffusers within Dⱼ₋₁ operate only on the prefix consisting of first k₁+ . . . +kⱼ₋₁ qubits, while O only changes relative phases.

$$\vert {w}_{3} 〉 = Id \text{?} ⊗ G \text{?} Id \text{?} ( \frac{1}{2 \text{?}} \vert η 〉 \vert {target}_{j}^{m} 〉 + \vert {u}_{1}^{j - 1} 〉 \vert \overline{{target}_{j}} 〉 \vert {target}_{j + 1}^{m} 〉 )$$

$$= \frac{1}{2 \text{?}} \vert η 〉 ( G \text{?} \vert {target}_{j} 〉 ) \vert {target}_{j + 1}^{m} 〉 + \vert {u}_{1}^{j - 1} 〉 ( G \text{?} \vert \overline{{target}_{j}} 〉 ) \vert {target}_{j + 1}^{m} 〉$$

$$= \frac{1}{2 \text{?}} \vert η 〉 ( \frac{2}{2 \text{?}} \vert \text{?} 〉 \vert {target}_{j} 〉 ) \vert {target}_{j + 1}^{m} 〉 + \vert {u}_{1}^{j - 1} 〉 ( ( 1 - \frac{2}{2 \text{?}} ) \vert \text{?} 〉 + \frac{1}{2 \text{?}} \vert \overline{{target}_{j}} 〉 ) \vert {target}_{j + 1}^{m} 〉$$

$$= \frac{1}{2 \text{?}} ( ( \frac{2}{2 \text{?}} - 1 ) \vert η 〉 ( 2 - \frac{2}{2 \text{?}} ) \vert {u}_{1} \text{?} 〉 ) \vert {target}_{j}^{m} 〉 +$$

$$= ( \frac{2}{2 \text{?}} \vert η 〉 + ( 1 - \frac{2}{2 \text{?}} ) \vert {u}_{1}^{j - 1} 〉 ) \vert \overline{{target}_{j}} 〉 \vert {target}_{j + 1}^{m} 〉 \vert {w}_{4} 〉 = {D}_{j - 1} \vert {w}_{3} 〉$$

$$= \frac{1}{2 \text{?}} ( ( \frac{2}{2 \text{?}} - 1 ) O \vert \text{?} 〉 \vert {target}_{j}^{m} 〉 + ( 2 - \frac{2}{2 \text{?}} ) {D}_{j - 1} \vert \text{?} 〉 \vert {target}_{j}^{m} 〉 )$$

$$+ ( \frac{2}{2 \text{?}} \vert η 〉 + ( 1 - \frac{2}{2 \text{?}} ) \vert {u}_{1}^{j - 1} 〉 ) \vert \overline{{target}_{j}} 〉 \vert {target}_{j + 1}^{m} 〉$$

$$\text{?} \text{indicates text missing or illegible when filed}$$

Note that we used Lemma [symbol] when applying Dⱼ₋₁ in the first summand. Now we can plug |ω [symbol] [symbol] into the expression defining βⱼ. Observe that the second summand in final expression is orthogonal to |target [symbol] , thus can be safely discarded. We obtain

$$\text{?}$$

$$\text{?} \text{indicates text missing or illegible when filed}$$

concluding the proof. □
Theorem 50. Fix any ε>0, and any N ∈ [symbol] of the form N=2ⁿ. Suppose we are given a quantum oracle O operating on n qubits that marks exactly one element. Then there exists a quantum circuit [symbol] which uses the oracle O at most

$$\text{?}$$

$$\text{?} \text{indicates text missing or illegible when filed}$$

times and uses at most [symbol] (log(1/c)\sqrt{N}) non-oracle basic gates, which finds the element marked by O with certainty.
Proof. We first begin by choosing a particular sequence of sizes for diffusers in the circuit Dₘ—namely kⱼ=(x+1)−j where x ∈ [symbol] ₊ is some parameter, and let us assume that the number of qubits we work with is precisely (x+1)+(x+1)·2+ . . . +(x+1)·m=(x+1)m(m+1)/2. From Lemma [symbol] , we get that the amplitude the circuit Dₘ in the marked state is given by the following recurrence

$$\text{?}$$

$$\text{?} \text{indicates text missing or illegible when filed}$$

To simplify the analysis of this recurrence, let us begin by substituting γⱼ=β_{j·}2^{(x+1)j(j-1)/4}. 2^{-j}, which yields

$$\text{?}$$

$$\text{?} \text{indicates text missing or illegible when filed}$$

We easily obtain the following inequality for j>0

γⱼ≥(1−2^{31 xj})(2^{-j}+γⱼ₋₁).

We may thus set

$$\text{?}$$

$$\text{?} \text{indicates text missing or illegible when filed}$$

and we easily obtain the inequality γⱼ≥δⱼ. We can express the solution to this recurrence as a sum

$$\text{?}$$

$$\text{?} \text{indicates text missing or illegible when filed}$$

where q=2^{-x}.

For a ∈ [symbol] ∪{∞}, let

$$\text{?}$$

$$\text{?} \text{indicates text missing or illegible when filed}$$

In terms of [symbol] (a), we can lower bound δₘ, as each term in our product is strictly less than 1, thus

$$\text{?}$$

$$\text{?} \text{indicates text missing or illegible when filed}$$

We now need a lower bound on [symbol] (∞), which we can obtain via Euler's Pentagonal Number Theorem [symbol] , which states that

$$\text{?}$$

$$\text{?} \text{indicates text missing or illegible when filed}$$

from which, one can easily derive the inequality

[symbol]

(∞)≥1−q−q².

Combining these inequalities we get

βₘ≥(2−2^{-m})(1−2^{-z}−2^{-2x})·2^{m}·2^{-n/2} (A3)

Using the same reasoning as in the proof of Theorem [symbol] , the inequality [symbol] allows us to bound the number of iterations of amplitude amplification by

$$\text{?}$$

$$\text{?} \text{indicates text missing or illegible when filed}$$

Each Dₘ has exactly 2^{m}−1 oracle calls, so one iteration has 2^{m+1}−1 oracle calls (tree, its conjugate and 1 extra call). Thus the number of oracle calls is at most

$$\text{?}$$

$$\text{?} \text{indicates text missing or illegible when filed}$$

so we are only a factor of

$$\text{?}$$

$$\text{?} \text{indicates text missing or illegible when filed}$$

away from optimal number of oracle calls.

Dₘ can be implemented with [symbol] (Σₖ₌₁^{m}k_{y·2}^{m-k}) gates. So we get at most

$$\text{?}$$

$$\text{?} \text{indicates text missing or illegible when filed}$$

non-oracle gates used by our algorithm. We use the following simple observation

$$\text{?}$$

$$\text{?} \text{indicates text missing or illegible when filed}$$

to get that the total number of nonoracle gates used by our algorithm is bounded by [symbol] (x·2^{n/2}). Thus, for any ε>0 that is sufficiently small, we obtain an algorithm that makes at most

$$\text{?}$$

$$\text{?} \text{indicates text missing or illegible when filed}$$

oracle calls, and uses at most

[symbol]

(log(ε⁻¹)2^{n/2})

non-oracle gates by setting x ∈ θ(log(ε⁻¹)). □

What is claimed is:

1. A method comprising:
preparing, via a state preparation circuit, an n choose k state on n qubits;
for each in a sequence of iterations, applying an oracle and microdiffuser circuit, wherein the microdiffuser circuit operates on a subset of n qubits of varying size over the sequence of iterations, and wherein for the jth iteration of the sequence of iterations, the microdiffuser circuit operates on a subset of n qubits of size mⱼ; and
applying a measurement to the n qubits.

2. The method of claim 1, wherein the microdiffuser circuit operates on the subset of n qubits of size mⱼ and further on one or more ancillas.

3. The method of claim 2, wherein the conditioning circuit operates further on the one or more ancillas.

4. The method of claim 1, wherein the measurement of the n qubits generates a search result that resolves an n-bit word by determining k bits of the n-bit word that are ON and n-k bits of the n-bit word that are OFF.

5. The method of claim 1, further comprising:
conditioning the n qubits based on a randomization.

6. The method of claim 5, wherein the randomization is one of:
a randomization of an ordering of the n qubits; or
a randomization of a grouping of the n qubits.

7. The method of claim 1, wherein the state preparation circuit operates on n data qubits (data₀ . . . dataₙ₋₁) and k+1 counter qubits (ctr₀ . . . ctrₖ), where n>1 and n≥k, and wherein the state preparation circuit includes:
an X gate applied to ctrₖ; and
an auxiliary quantum circuit, Cₖⁿ, that operates on the n data qubits (data₀ . . . dataₙ₋₁) and the k+1 counter qubits (ctr₀ . . . ctrₖ).

8. The method of claim 7, wherein the auxiliary quantum circuit Cₖⁿ, is generated by:
providing an auxiliary quantum circuit C₁¹;
recursively constructing Cₖⁿ by:
for j=1 . . . k, applying an
$$RY ( 2 arccos \sqrt{\frac{n - j}{n}} )$$
gate on data₀ controlled on the jth of the k+1 counter qubits;
controlled on data₀, decrement the counter register; and
apply C_{min(n-1,k)}ⁿ⁻¹ on qubits data₀ . . . dataₙ₋₁, and ctr₀ . . . ctr_{min(n-1,k)}.

9. The method of claim 1, wherein the microdiffuser circuit is a microdiffuser circuit, G_{k,m}ⁿ, that operates on m data qubits and j₁+1 ancillas, where n> m and j₁=min(m,k), and wherein the microdiffuser circuit comprises:
a first auxiliary quantum circuit, (Cⱼ₁^{m})^{†} that operates on the m data qubits (data₀ . . . dataₙ₋₁) and the j₁+1 ancillas;
a first plurality of X gates applied to the m data qubits after operation of the first auxiliary quantum circuit; and
a controlled Z gate applied to one of the m data qubits and controlled by m−1 remaining data qubits after operation of the first plurality of X gates;

10. The method of claim 9, wherein the microdiffuser circuit, G_{k,m}ⁿ, further includes:
a second plurality of X gates applied to the m data qubits after operation of the controlled Z gate; and
a second auxiliary quantum circuit, (Cⱼ₁^{m}) that operates on the m data qubits (data₀ . . . dataₙ₋₁) after operation of the second plurality of X gates and the j₁+1 ancillas after operation of the first auxiliary quantum circuit.

11. A quantum circuit comprising:
a state preparation circuit, that prepares an n choose k state on n qubits;
an oracle; and
a microdiffuser circuit, wherein for each in a sequence of iterations, the oracle and the microdiffuser circuit are applied, wherein the microdiffuser circuit operates on a subset of n qubits of varying size over the sequence of iterations, wherein for the jth iteration of the sequence of iterations, the microdiffuser circuit operates on a subset of n qubits of size mⱼ, and wherein a measurement is applied to the n qubits.

12. The quantum circuit of claim 11, wherein the microdiffuser circuit operates on the subset of n qubits of size mⱼ and further on one or more ancillas.

13. The quantum circuit of claim 12, wherein the conditioning circuit operates further on the one or more ancillas.

14. The quantum circuit of claim 11, wherein the measurement of the n qubits generates a search result that resolves an n-bit word by determining k bits of the n-bit word that are ON and n-k bits of the n-bit word that are OFF.

15. The quantum circuit of claim 11, wherein the n qubits are conditioned based on a randomization.

16. The quantum circuit of claim 15, wherein the randomization is one of:
a randomization of an ordering of the n qubits; or
a randomization of a grouping of the n qubits.

17. The quantum circuit of claim 11, wherein the state preparation circuit operates on n data qubits (data₀ . . . dataₙ₋₁) and k+1 counter qubits (ctr₀ . . . ctrₖ), where n>1 and n≥k, and wherein the state preparation circuit includes:
an X gate applied to ctrₖ; and
an auxiliary quantum circuit, Cₖⁿ, that operates on the n data qubits (data₀ . . . dataₙ₋₁) and the k+1 counter qubits (ctr₀ . . . ctrₖ).

18. The quantum circuit of claim 17, wherein the auxiliary quantum circuit Cₖⁿ, is generated by:
providing an auxiliary quantum circuit C₁¹;
recursively constructing Cₖⁿ by:
for j=1 . . . k, applying an
$$RY ( 2 arccos \sqrt{\frac{n - j}{n}} )$$
gate on data₀ controlled on the jth of the k+1 counter qubits;
controlled on data₀, decrement the counter register; and
apply C_{min(n-1,k)}ⁿ⁻¹ on qubits data₀ . . . dataₙ₋₁, and ctr₀ . . . ctr_{min(n-1,k)}.

19. The quantum circuit of claim 11, wherein the microdiffuser circuit is a microdiffuser circuit, G_{k,m}ⁿ, that operates on m data qubits and j₁+1 ancillas, where n> m and j₁=min(m,k), and wherein the microdiffuser circuit comprises:
a first auxiliary quantum circuit, (Cⱼ₁^{m})^{†} that operates on the m data qubits (data₀ . . . dataₙ₋₁) and the j₁+1 ancillas;
a first plurality of X gates applied to the m data qubits after operation of the first auxiliary quantum circuit; and
a controlled Z gate applied to one of the m data qubits and controlled by m−1 remaining data qubits after operation of the first plurality of X gates1

20. The quantum circuit of claim 19, wherein the microdiffuser circuit, G_{k,m}ⁿ, further includes:
a second plurality of X gates applied to the m data qubits after operation of the controlled Z gate; and
a second auxiliary quantum circuit, (Cⱼ₁^{m}) that operates on the m data qubits (data₀ . . . dataₙ₋₁) after operation of the second plurality of X gates and the j₁+1 ancillas after operation of the first auxiliary quantum circuit.
